(19) United States
(12) Patent Application Publication
(10) Pub. No.: US 2013/0211807 A1
(43) Pub. Date: Aug. 15, 2013

(54) Method and System for Fracturing a Formation

(71) Applicants: Elizabeth Land Templeton-Barrett, Houston, TX (US); Xianyun Wu, Sugar Land, TX (US); Michael S. Chelf, Humble, TX (US); Brian R. Crawford, Missouri City, TX (US); Bruce A. Dale, Sugar Land, TX (US); Yueming Liang, Sugar Land, TX (US); Kevin H. Searles, Kingwood, TX (US); Peter Griffin Smith, JR., Houston, TX (US); Marshall I. Sundberg, Houston, TX (US)

(72) Inventors: Elizabeth Land Templeton-Barrett, Houston, TX (US); Xianyun Wu, Sugar Land, TX (US); Michael S. Chelf, Humble, TX (US); Brian R. Crawford, Missouri City, TX (US); Bruce A. Dale, Sugar Land, TX (US); Yueming Liang, Sugar Land, TX (US); Kevin H. Searles, Kingwood, TX (US); Peter Griffin Smith, JR., Houston, TX (US); Marshall I. Sundberg, Houston, TX (US)

(21) Appl. No.: 13/820,939

(22) PCT Filed: Oct. 14, 2011
(86) PCT No.: PCT/US11/56358

§ 371 Date: Mar. 5, 2013

Related U.S. Application Data
(60) Provisional application No. 61/407,249, filed on Oct. 27, 2010.
(60) Provisional application No. 61/544,757, filed on Oct. 7, 2011.
(60) Provisional application No. 61/544,766, filed on Oct. 7, 2011.

(51) Int. Cl. E21B 43/26; G06F 17/50; E21B 43/30

(52) U.S. Cl. CPC E21B 43/26; E21B 43/30; G06F 17/5009
USPC 703/10; 166/313; 166/52

(57) ABSTRACT

Systems and methods for fracturing a formation are provided. A method includes generating a subsurface model including the production formation and a zone proximate to the production formation. A number of scenarios are simulated in which a volumetric change is created in the zone proximate to the production formation. A scenario is selected from the plurality of scenarios to stimulate the production formation. The scenario is performed to create a fracture field in the production formation.

### CROSS-REFERENCE TO RELATED APPLICATION

This application claims the benefit of U.S. Provisional Patent Application No. 61/407,249 filed Oct. 27, 2010 entitled METHOD AND SYSTEM FOR FRACTURE STIMULATION, and also claims benefit to U.S. Provisional Application No. 61/544,757, filed Oct. 7, 2011, entitled METHOD AND SYSTEM FOR FRACTURE STIMULATION BY CYCLIC FORMATION SETTLING AND DISPLACEMENT and U.S. Provisional Application No. 61/544,766, filed Oct. 7, 2011 entitled METHOD AND SYSTEM FOR FRACTURE STIMULATION BY FORMATION DISPLACEMENT.

### FIELD OF THE INVENTION

Exemplary embodiments of the present techniques relate to a method and system for fracture stimulation of subterranean formations to enhance the recovery of hydrocarbons. Specifically, an exemplary embodiment provides for creating fractures and other flow paths by delamination and rubblization of formations.

### BACKGROUND

This section is intended to introduce various aspects of the art that may be topically associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

As hydrocarbon reservoirs that are easily harvested, such as reservoirs on land or reservoirs located in shallow ocean water, are used up, other hydrocarbon sources must be used to keep up with energy demands. Such reservoirs may include any number of unconventional hydrocarbon sources, such as biomass, deep-water oil reservoirs, and natural gas from other sources.

One such unconventional hydrocarbon source is natural gas produced from formations that form unconventional gas reservoirs, including, for example, shale and coal seams. Because unconventional gas reservoirs may have insufficient permeability to allow significant fluid flow to a wellbore, many of such unconventional gas reservoirs are currently not considered as practical sources of natural gas. However, natural gas has been produced for years from low permeability reservoirs having natural fractures. Furthermore, a significant increase in shale gas production has resulted from hydraulic fracturing, which can be used to create extensive artificial fractures around wellbores. When combined with horizontal drilling, which is often used with wells in tight gas reservoirs, the hydraulic fracturing may allow formerly unpractical reservoirs to be commercially viable.

The fracturing process is complicated and often requires numerous hydraulic fractures in a single well and numerous wells for an economic field development. More efficient fracturing processes may provide a more productive reservoir. In other words, a greater amount of the gas, or other hydrocarbon, trapped in a relatively non-porous reservoir, such as a tight gas, tight sand, shale layer or even a coal seam may be harvested. Accordingly, numerous researchers have explored ways to improve fracturing.

For example, U.S. Pat. No. 3,455,391, to Matthews, et al., discloses a process for horizontally fracturing subterranean earth formations. The process is performed by injecting a hot fluid at high pressure, until vertical fractures are formed and then closed due to thermal expansion of the earth formation. A fluid is then injected at a pressure sufficient to form horizontal fractures.

A similar process is disclosed in U.S. Pat. No. 3,613,785, to Closman and Phocas. In this process a wellbore is extended into the formation and a vertical fracture is generated by pressurizing the borehole. A hot fluid is injected into the formation to heat the formation, until thermal stressing of the formation matrix material causes the horizontal compressive stress in the formation to exceed the vertical compressive stress at a location selected for a second well. Hydraulically fracturing the formation through this second well can form a horizontal fracture extending into the formation.

Other approaches have focused on relieving stress in the formation, for example, by cavitation of the formation. For example, U.S. Pat. No. 5,147,111, to Montgomery, discloses a method for cavity induced stimulation of coal degasification wells. The method can be used for improving the initial production of fluids, such as methane, from a coal seam. To perform the method, a well is drilled and completed into the seam. A tubing string is run into the hole and liquid carbon dioxide is pumped down the tubing while a backpressure is maintained on the well annulus. The pumping is stopped, and the pressure is allowed to build until it reached a desired elevated pressure, for example, 1500 to 2000 psia. The pressure is quickly released, causing the coal to fail and fragment into particles. The particles are removed to form a cavity in the seam. The cavity can allow expansion of the coal, potentially leading to opening of cleats within the coal seam.

A similar concept has been described in Ukraine Patent No. 35282, which discloses another method for coal degasification, but through subsurface gasification of an underburden coal seam (a coal seam that underlies the gas-containing formation). In this process, wellbores are drilled through an underburden coal bed so that a gasification catalyst can be applied. Once gasification occurs and lowers the underburden pressure due to depletion, subsidence of the overburden (e.g., the layer containing the gas) occurs due to gravitational loading. The subsidence can potentially create microfractures within the overburden reservoir, thereby allowing improved gas migration to the degassing wells.

It has also been noted that vertical wells and mining processes can lower stress points on coal seams, leading to increases in the production of coal bed methane. For example, S. Sang, et al., “Stress relief coalbed methane drainage by surface vertical wells in China,” International Journal of Coal Geology, Volume 82, 196-203 (2010), presents a summary of studies on improved coalbed methane production by stress relief. The paper summarizes the status of engineering practice, technology, and research related to stress relief coalbed methane (CBM) drainage using surface wells in China during the past 10 years. Comments are provided on the theory and technical progress of this method. In high gas mining areas, such as the Huainan, Huaibei and Tiefa mining areas, characterized by heavily sheared coals with relatively low permeability, stress relief CBM surface well drainage has been successfully implemented and has broad acceptance as a CBM exploitation technology. The fundamental theories underpinning stress relief CBM surface well drainage include elements relating to: (1) formation layer deformation theory, vertical zoning and horizontal partitioning, and the change in the stress condition in mining stopes; (2) a theory regarding an Abscission Circle in the development of mining horizontal abscission fracture and vertical broken fracture in overlaying formations; and (3) the theory of stress relief inducing permeability increase in protected coal seams during mining; and the gas migration—accumulation theory of stress relief CBM surface well drainage.

Other techniques for increasing production from coal beds, and other reservoirs, have focused on in-situ pyrolysis of hydrocarbons in a reservoir, followed by production of hydrocarbons from the reservoir. All of these techniques above have focused on the treatment of the hydrocarbon reservoir itself. Further, some techniques have taught that relieving a stress on a reservoir may enhance the production of hydrocarbons, for example, by allowing cleats to open up in coal seams.

Related information may be found in S. E. Laubach, et al., “Characteristics and origins of coal cleat: A review,” International Journal of Coal Geology 35 (1998), 175-207; Ian Palmer, “Coalbed methane completions: A world view,” International Journal of Coal Geology 82 (2010), 184-195; Jack A. Pashin, “Stratigraphy and structure of coalbed methane reservoirs in the United States: An overview,” International Journal of Coal Geology 35 (1998), 209-240; Pablo F. Sanz, et al., “Mechanical models of fracture reactivation and slip on bedding surfaces during folding of the asymmetric anticline at Sheep Mountain, Wy.,” Journal of Structural Geology 30 (2008), 1177-1191; V. Palchik, “Localization of mining-induced horizontal fractures along formation layer interfaces in overburden: field measurements and prediction,” Environ. Geol. 48 (2005), 68-80; and Stephen P. Laubach, et al., “Differential compaction of interbedded sandstone and coal,” from: Cosgrove, J. W. and Ameen, M. S. (eds.), Forced Folds and Fractures, Geological Society of London, Special Publications, 169,51-60 (The Geological Society of London 2000).

### SUMMARY

An embodiment of the present techniques provides a method for fracturing a formation. The method includes generating a subsurface model that includes the production formation and a zone proximate to the production formation. A plurality of scenarios is simulated, in which a volumetric change is created in the zone proximate to the production formation. A scenario is selected from the plurality of scenarios to stimulate the production formation. The scenario is performed to create a fracture field in the production formation.

Another embodiment of the present techniques provides a method for production of a hydrocarbon from a reservoir. The method includes simulating a plurality of scenarios in which a volumetric change is created in a zone proximate to a production formation. One of the plurality of scenarios is selected to stimulate the production formation. The scenario is implemented to mechanically stress the production formation and create a fracture field. The fracture field is fluidically coupled to a production well and hydrocarbons are produced from the production well.

Another embodiment provides a hydrocarbon production system that includes a hydrocarbon reservoir and a zone proximate to the hydrocarbon reservoir. A stimulation well is drilled to the zone. The system also includes a stimulation system configured to create a volumetric change in the zone based, at least in part, on a scenario identified by a simulation of the hydrocarbon reservoir and the zone.

### BRIEF DESCRIPTION OF THE DRAWINGS

The advantages of the present techniques are better understood by referring to the following detailed description and the attached drawings, in which:

FIG. 1 is a diagram of a hydraulic fracturing process;

FIG. 2 is a drawing of a local stress state for an element in a hydrocarbon bearing subterranean formation;

FIG. 3 is a drawing of a opening mode (mode 1) of fracture formation, commonly resulting from a standard hydraulic fracturing process;

FIG. 4 is an exemplified drawing of a well treatment system such as a hydraulic fracturing system, wherein a zone below a hydrocarbon bearing subterranean formation is subjected to a volumetric expansion, which can place stress on the hydrocarbon bearing subterranean formation leading to fracturing;

FIG. 5 is a block diagram of a method for stimulation of a hydrocarbon bearing subterranean formation by treating a formation outside of the reservoir;

FIG. 6A is a more detailed schematic view of a delamination fracture stimulation performed by inflating a zone proximate to a production zone;

FIG. 6B is a more detailed schematic view of a delamination fracture stimulation performed by deflating a zone proximate to a production zone;

FIG. 7 is a drawing of two modes of sliding fracture formation that may participate in delamination fracture stimulation as discussed herein;

FIG. 8 is a drawing of rubblization during shearing at a fracture interface or boundary;

FIG. 9 is a drawing of an azimuthal rotation of fracture planes within a formation that may occur as a result of cyclic treatment of the formation;

FIG. 10 is a drawing of a well passing through a reservoir interval and a treatment interval, in which a notch has been formed in the treatment interval;

FIG. 11 is a drawing of the stress distribution in the formation around the tip of a notch;

FIG. 12A is a drawing of a delamination fracturing process illustrating the use of a separate production well and treatment well to cause the formation of delamination fracture through a volume increase in a target zone;

FIG. 12B is a drawing of a delamination fracturing process illustrating the use of a separate production well and treatment well to cause the formation of delamination fracture through a volume decrease in a target zone;

FIG. 13 is a method for generating a design for a treatment using stress applied to a treatment interval to place stress on a reservoir interval;

FIG. 14 is a more detailed view of a method for generating the initial treatment design of the workflow;

FIG. 15 is a more detailed view of a method for performing the delamination fracture (D-Frac) forward modeling;

FIG. 16 is a drawing of a conceptual model of a reservoir interval and a treatment interval;

FIG. 17 shows three normalized plots indicating calculated displacements in a reservoir interval caused by displacements in a treatment interval or zone;

FIG. 18 shows three normalized plots illustrating stress change shape functions caused by displacements in a treatment interval;

FIG. 19 is a drawing of a stacked treatment technique that may be useful for increasing the effects of the treatment of a zone on the hydrocarbon bearing subterranean formation; and

FIG. 20 is a block diagram of a computer system that may be used to perform a simulation of treatments.

### DETAILED DESCRIPTION

In the following detailed description section, the specific embodiments of the present techniques are described in connection with exemplary embodiments. However, to the extent that the following description is specific to a particular embodiment or a particular use of the present techniques, this is intended to be for exemplary purposes only and simply provides a description of the exemplary embodiments. Accordingly, the present techniques are not limited to the specific embodiments described below, but rather, such techniques include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

The “Bulk modulus” of a rock sample from a formation relates the pressure to the volume change given by the dilationₖₖ. It is an elastic property of the material and is usually denoted by the English alphabet K having units the same as that of stress, and is given by:

$$K = \frac{3 λ - 2 μ}{3} .$$

“Cavitation completion” or “cavitation” is a process by which an opening may be made in a formation. Generally, cavitation is performed by drilling a well into a formation. The formation is then pressurized in the vicinity of the well. The pressure is suddenly released, causing the material in the vicinity of the well to fragment. The fragments and debris may then be swept to the surface through the well by circulating a fluid through the well.

“Cleat system” is the system of naturally occurring joints that are created as a coal seam forms over geologic time. A cleat system allows for the production of natural gas if the provided permeability to the coal seam is sufficient.

“Coal” is a solid hydrocarbon, including, but not limited to, lignite, sub-bituminous, bituminous, anthracite, peat, and the like. The coal may be of any grade or rank.

This can include, but is not limited to, low grade, high sulfur coal that is not suitable for use in coal-fired power generators due to the production of emissions having high sulfur content.

“Coalbed methane” (CBM) is a natural gas that is adsorbed onto the surface of coal. CBM may be substantially comprised of methane, but may also include ethane, propane, and other hydrocarbons. Further, CBM may include some amount of other gases, such as carbon dioxide (CO₂) and nitrogen (N₂).

A “compressor” is a machine that increases the pressure of a gas by the application of work (compression). Accordingly, a low pressure gas (for example, 5 psig) may be compressed into a high-pressure gas (for example, 1000 psig) for transmission through a pipeline, injection into a well, or other processes.

“Directional drilling” is the intentional deviation of the wellbore from the path it would naturally take. In other words, directional drilling is the steering of the drill string so that it travels in a desired direction. Directional drilling can be used for increasing the drainage of a particular well, for example, by forming deviated branch bores from a primary borehole. Directional drilling is also useful in the marine environment where a single offshore production platform can reach several hydrocarbon bearing subterranean formations or reservoirs by utilizing a plurality of deviated wells that can extend in any direction from the drilling platform. Directional drilling also enables horizontal drilling through a reservoir to form a horizontal wellbore. As used herein, “horizontal wellbore” represents the portion of a wellbore in a subterranean zone to be completed which is substantially horizontal or at an angle from vertical in the range of from about 15° to about 75°. A horizontal wellbore may have a longer section of the wellbore traversing the payzone of a reservoir, thereby permitting increases in the production rate from the well.

“Exemplary” is used exclusively herein to mean “serving as an example, instance, or illustration.” Any embodiment described herein as exemplary is not to be construed as preferred or advantageous over other embodiments.

A “facility” is tangible piece of physical equipment, or group of equipment units, through which hydrocarbon fluids are either produced from a reservoir or injected into a reservoir. In its broadest sense, the term facility is applied to any equipment that may be present along the flow path between a reservoir and its delivery outlets, which are the locations at which hydrocarbon fluids either leave the model (produced fluids) or enter the model (injected fluids). Facilities may comprise production wells, injection wells, well tubulars, wellhead equipment, gathering lines, manifolds, pumps, compressors, separators, surface flow lines, and delivery outlets. In some instances, the term “surface facility” is used to distinguish those facilities other than wells.

As used herein, the force “1” could be compressional, leading to longitudinally compressing the strength member, or tensional, leading to longitudinally extending the strength member. In the case of a strength member in a seismic section, the force will typically be tension.

“Formation” refers to a body or section of geologic strata, structure, formation, or other subsurface solids or collected material that is sufficiently distinctive and continuous with respect to other geologic strata or other characteristics that it can be mapped, for example, by seismic techniques. A formation can be a body of geologic strata of predominantly one type of rock or a combination of types of rock, or a fraction of strata having substantially common set of characteristics. A formation can contain one or more hydrocarbon-bearing subterranean formations. Note that the terms formation, hydrocarbon bearing subterranean formation, reservoir, and interval may be used interchangeably, but may generally be used to denote progressively smaller subsurface regions, zones, or volumes. More specifically, a geologic formation may generally be the largest subsurface region, a hydrocarbon reservoir or subterranean formation may generally be a region within the geologic formation and may generally be a hydrocarbon-bearing zone, a formation, reservoir, or interval having oil, gas, heavy oil, and any combination thereof. An interval or production interval may generally refer to a sub-region or portion of a reservoir. A hydrocarbon-bearing zone, or production formation, may be separated from other hydrocarbon-bearing zones by zones of lower permeability such as mudstones, shales, or shale-like (highly compacted) sands. In one or more embodiments, a hydrocarbon-bearing zone may include heavy oil in addition to sand, clay, or other porous solids.

A “fracture” is a crack, delamination, surface breakage, separation, crushing, rubblization, or other destruction within a geologic formation or fraction of formation that is not related to foliation or cleavage in metamorphic formation, along which there has been displacement or movement relative to an adjacent portion of the formation. A fracture along which there has been lateral displacement may be termed a fault. When walls of a fracture have moved only normal to each other, the fracture may be termed a joint. Fractures may enhance permeability of rocks greatly by connecting pores together, and for that reason, joints and faults may be induced mechanically in some reservoirs in order to increase fluid flow.

“Fracturing” refers to the structural degradation of a treatment interval, such as a subsurface shale formation, from applied thermal or mechanical stress. Such structural degradation generally enhances the permeability of the treatment interval to fluids and increases the accessibility of the hydrocarbon component to such fluids. Fracturing may also be performed by degrading rocks in treatment intervals by chemical means. “Fracture network” refers to a field or network of interconnecting fractures, usually formed during hydraulic fracturing. A “fracture field” is a group of fractures, which may or may not be interconnected, and are created by a single fracturing event, such as by a volumetric change in a zone proximate to a target formation, which fractures the target formation.

“Fracture gradient” refers to an equivalent fluid pressure sufficient to create or enhance one or more fractures in the subterranean formation. As used herein, the “fracture gradient” of a layered formation also encompasses a parting fluid pressure sufficient to separate one or more adjacent bedding planes in a layered formation. It should be understood that a person of ordinary skill in the art could perform a simple leak-off test on a core sample of a formation to determine the fracture gradient of a particular formation.

“Geomechanical stress” or “stress” including a change related thereto, or similar phrase, refers generally to the forces external to or interior to a formation acting upon or within such formation. The forces may define a stress state, condition, or property of a formation, zone, or other geologic strata, and/or any fluid contained therein. In embodiments, the stress state may be manipulated to control the creation of fractures in particular directions.

“Heat source” is any system for providing heat to at least a portion of a formation substantially by conductive or radiative heat transfer. For example, a heat source may include electric heaters such as an insulated conductor, an elongated member, or a conductor disposed in a conduit. Other heating systems may include electric resistive heaters placed in wells, electrical induction heaters placed in wells, circulation of hot fluids through wells, resistively heated conductive propped fractures emanating from wells, downhole burners, exothermic chemical reactions, and in situ combustion. A heat source may also include systems that generate heat by burning a fuel external to or in a formation. The systems may be surface burners, downhole gas burners, flameless distributed combustors, and natural gas distributed combustors. In some embodiments, heat provided to or generated in one or more heat sources may be supplied by other sources of energy. The other sources of energy may directly heat a formation, or the energy may be applied to a transfer medium that directly or indirectly heats the formation. For example, an “electrofrac heater” may use electrical conductive propped fractures to apply heat to the formation. In an electrofrac heater, a formation is hydraulically fractured and a graphite proppant is used to prop the fractures open. An electric current may then be passed through the graphite proppant causing it to generate heat, which heats the surrounding formation.

“Hydraulic fracturing” is used to create single or branching fractures that extend from the wellbore into reservoir formations so as to stimulate the potential for production. A fracturing fluid, typically a viscous fluid, is injected into the formation with sufficient pressure to create and extend a fracture, and a proppant is used to “prop” or hold open the created fracture after the hydraulic pressure used to generate the fracture has been released. When pumping of the treatment fluid is finished, the fracture “closes.” Loss of fluid to a permeable formation results in a reduction in fracture width until the proppant supports the fracture faces. The fracture may be artificially held open by injection of a proppant material. Hydraulic fractures may be substantially horizontal in orientation, substantially vertical in orientation, or oriented along any other plane. Generally, the fractures tend to be vertical at greater depths, due to the increased magnitude of the vertical stress relative to the horizontal stresses. As used herein, fracturing may take place in portions of a formation outside of a hydrocarbon bearing subterranean formation in order to enhance hydrocarbon production from the hydrocarbon bearing subterranean formation.

“Hydrocarbon production” refers to any activity associated with extracting hydrocarbons from a well or other opening, Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

“Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen, and/or sulfur. Hydrocarbons may be produced from hydrocarbon bearing subterranean formations through wells penetrating a hydrocarbon containing formation. Hydrocarbons derived from a hydrocarbon bearing subterranean formation may include, but are not limited to, kerogen, bitumen, pyrobitumen, asphaltenes, oils, natural gas, or combinations thereof. Hydrocarbons may be located within or adjacent to mineral matrices within the earth. Matrices may include, but are not limited to, sedimentary rock, sands, silicilytes, carbonates, diatomites, and other porous media.

A “hydraulic fracture” is a fracture at least partially propagated into a formation, wherein the fracture is created through injection of pressurized fluids into the formation. While the term “hydraulic fracture” is used, the techniques described herein are not limited to use in hydraulic fractures. The techniques may be suitable for use in any fractures created in any manner considered suitable by one skilled in the art. Hydraulic fractures may be substantially horizontal in orientation, substantially vertical in orientation, or oriented along any other plane. Generally, the fractures tend to be vertical at greater depths, due to the increased magnitude of the vertical stress relative to the horizontal stresses.

“Ideally elastic” refers to a material in which a body formed of the material recovers its original form completely upon removal of the forces causing the deformation, and a material that has a one-to-one, i.e., unique relationship between the state of stress and the state of strain at a given temperature. For many materials, strain is directly proportional to the stress, at least at stresses below the yield strength of a material, This linear relationship between strain ᵢⱼ and stress ᵢⱼ occurring at stresses below the yield strength is known as the generalized Hooke's law, and is represented by the formula:

σᵢⱼ=Cᵢⱼₖₗεₖₗ

where summation convention is employed, meaning that in Cartesian coordinates whenever the same letter subscript occurs twice in a term, that subscript is to be given all possible values and the results added together, and here i,j,k,l each take the values 1,2,3. The 9 equations represented above contain 81 elastic constants, Cᵢⱼₖₗ, but symmetry of the stress tensor, ᵢⱼ, and existence of a strain energy function reduce the number of distinct constants to 21. A “plane of elastic symmetry” is a plane in which the elastic constants at a point have the same values for every pair of coordinate systems which are mirror images of each other in a certain plane.

“Imbibition” refers to the incorporation of a fracturing fluid into a fracture face by capillary action. Imbibition may result in decreases in permeation of a formation fluid across the fracture face, and is known to be a form of formation damage. For example, if the fracturing fluid is an aqueous fluid, imbibition may result in lower transport of organic materials, such as hydrocarbons, across the fracture face, resulting in decreased recovery. The decrease in hydrocarbon transport may outweigh any increases in fracture surface area resulting in no net increase in recovery, or even a decrease in recovery, after fracturing.

“In-Situ” or “insitu” refers to a state, condition, or property of a geologic formation, strata, zone, and/or fluids therein, prior to changing or altering such state, condition, or property by an action affecting the formation and/or fluids therein. Changes to the insitu properties may be effected by substantially any action upon the formation, such as producing or removing fluids from a formation, injecting or introducing fluids or other materials into a formation, stimulating a formation, causing a collapse such as permitting a wellbore collapse or dissolving supporting strata, removing adjacent formation or fluid, heating or cooling the formation, or other action that effects change in the state, condition or property of the formation. The insitu state may or may not be the virgin or original state of the formation, but is a relative term that may in fact merely reference a state that exists prior to undertaking some action upon the formation.

An “isotropic” material is one in which the body's elastic constants, Cᵢⱼₖₗ, are the same in every set of reference axes at any point for a given situation. For a such a material, the number of distinct elastic constants is two, and the strains can be related to the stresses by Hooke's Law:

σᵢⱼ=πδᵢⱼεₖₖ+2μεᵢⱼ,

where the distinct elastic constants are and, the Lamé constants. is also known as the “modulus of rigidity” or “shear modulus” and is sometimes expressed as G. Three additional constants, E, K, and can be defined as combinations of the Lamé constants.

As used herein, “material properties” represents any number of physical constants that reflect the behavior of a rock. Such material properties may include, for example, Young's modulus (E), Poisson's Ratio ( ), tensile strength, compressive strength, shear strength, creep behavior, and other properties. The material properties may be measured by any combinations of tests, including, among others, a “Standard Test Method for Unconfined Compressive Strength of Intact Rock Core Specimens,” ASTM D 2938-95; a “Standard Test Method for Splitting Tensile Strength of Intact Rock Core Specimens [Brazilian Method],” ASTM D 3967-95a Reapproved 1992; a “Standard Test Method for Determination of the Point Load Strength Index of Rock,” ASTM D 5731-95; “Standard Practices for Preparing Rock Core Specimens and Determining Dimensional and Shape Tolerances,” ASTM D 4435-01; “Standard Test Method for Elastic Moduli of Intact Rock Core Specimens in Uniaxial Compression,” ASTM D 3148-02; “Standard Test Method for Triaxial Compressive Strength of Undrained Rock Core Specimens Without Pore Pressure Measurements,” ASTM D 2664-04; “Standard Test Method for Creep of Cylindrical Soft Rock Specimens in Uniaxial Compressions,” ASTM D 4405-84, Reapproved 1989; “Standard Test Method for Performing Laboratory Direct Shear Strength Tests of Rock Specimens Under Constant Normal Stress,” ASTM D 5607-95; “Method of Test for Direct Shear Strength of Rock Core Specimen,” U.S. Military Rock Testing Handbook, RTH-203-80, available at “http://www.wes.army.mil/SL/MTC/handbook/RT/RTH/203-80.pdf' (last accessed on Oct. 1, 2010); and “Standard Method of Test for Multistage Triaxial Strength of Undrained Rock Core Specimens Without Pore Pressure Measurements,” U.S. Military Rock Testing Handbook, available at http://www.wes.army.mil/SL/MTC/ handbook/RT/RTH/204-80.pdf” (last accessed on Jun. 25, 2010). One of ordinary skill will recognize that other methods of testing rock specimens from formations may be used to determine the physical constants used herein.

“Natural gas” refers to various compositions of raw or treated hydrocarbon gases. Raw natural gas is primarily comprised of light hydrocarbons such as methane, ethane, propane, butanes, pentanes, hexanes and impurities like benzene, but may also contain small amounts of non-hydrocarbon impurities, such as nitrogen, hydrogen sulfide, carbon dioxide, and traces of helium, carbonyl sulfide, various mercaptans, or water. Treated natural gas is primarily comprised of methane and ethane, but may also contain small percentages of heavier hydrocarbons, such as propane, butanes, and pentanes, as well as small percentages of nitrogen and carbon dioxide.

An “orthotropic” material is one that has three symmetry planes and nine independent elastic constants if a strain-energy function exists. If the principal axes of strain coincide with the symmetry axes, then so do the principal axes of stress.

“Overburden” refers to the subsurface formation overlying the formation containing one or more hydrocarbon-bearing zones (the reservoirs). For example, overburden may include rock, shale, mudstone, or wet/tight carbonate (such as an impermeable carbonate without hydrocarbons). An overburden may include a hydrocarbon-containing layer that is relatively impermeable. In some cases, the overburden may be permeable.

“Overburden stress” refers to the load per unit area or stress overlying an area or point of interest in the subsurface from the weight of the overlying sediments and fluids. In one or more embodiments, the “overburden stress” is the load per unit area or stress overlying the hydrocarbon-bearing zone that is being conditioned or produced according to the embodiments described. In general, the magnitude of the overburden stress may primarily depend on two factors: 1) the composition of the overlying sediments and fluids, and 2) the depth of the subsurface area or formation. Similarly, underburden refers to the subsurface formation underneath the formation containing one or more hydrocarbon-bearing zones (reservoirs).

“Permeability” is the capacity of a formation to transmit fluids through the interconnected pore spaces of the rock. Permeability may be measured using Darcy's Law: Q=(k ΔP A)/(μ L), where Q=flow rate (cm³/s), ≢P=pressure drop (atm) across a cylinder having a length L (cm) and a cross-sectional area A (cm²), μ=fluid viscosity (cp), and k=permeability (Darcy). The customary unit of measurement for permeability is the millidarcy. The term “relatively permeable” is defined, with respect to formations or portions thereof, as an average permeability of 10 millidarcy or more (for example, 10 or 100 millidarcy), The term “relatively low permeability” is defined, with respect to formations or portions thereof, as an average permeability of less than about 10 millidarcy. An impermeable layer generally has a permeability of less than about 0.1 millidarcy. By these definitions, shale may be considered impermeable, for example, ranging from about 0.1 millidarcy (100 microdarcy) to as low as 0.00001 millidarcy (10 nanodarcy).

“Porosity” is defined as the ratio of the volume of pore space to the total bulk volume of the material expressed in percent. Although there often is an apparent close relationship between porosity and permeability, because a highly porous formation may be highly permeable, there is no real relationship between the two; a formation with a high percentage of porosity may be very impermeable because of a lack of communication between the individual pores, capillary size of the pore space or the morphology of structures constituting the pore space. For example, the diatomite in one exemplary rock type found in formations, Belridge, has very high porosity, at about 60%, but the permeability is very low, for example, less than about 0.1 millidarcy.

The “Poisson's ratio” of a rock sample from a formation is the ratio of a unit of lateral contraction to a unit of longitudinal extension for tension. It is a dimensionless elastic property of the material and is usually denoted by the Greek alphabet, and is given by:

$$v = \frac{λ}{2 ( λ + μ )} .$$

“Pressure” refers to a force acting on a unit area. Pressure is usually shown as pounds per square inch (psi). “Atmospheric pressure” refers to the local pressure of the air. Local atmospheric pressure is assumed to be 14.7 psia, the standard atmospheric pressure at sea level. “Absolute pressure” (psia) refers to the sum of the atmospheric pressure plus the gauge pressure (psig). “Gauge pressure” (psig) refers to the pressure measured by a gauge, which indicates only the pressure exceeding the local atmospheric pressure (a gauge pressure of 0 psig corresponds to an absolute pressure of 14.7 psia).

As previously mentioned, a “reservoir” or “hydrocarbon reservoir” is defined as a pay zone or production interval (for example, a hydrocarbon bearing subterranean formation) that includes sandstone, limestone, chalk, coal, and some types of shale. Pay zones can vary in thickness from less than one foot (0.3048 m) to hundreds of feet (hundreds of m). The permeability of the reservoir formation provides the potential for production.

“Reservoir properties” and “Reservoir property values” are defined as quantities representing physical attributes of rocks containing reservoir fluids. The term “reservoir properties” as used in this application includes both measurable and descriptive attributes. Examples of measurable reservoir property values include impedance to P-waves, impedance to S-waves, porosity, permeability, water saturation, and fracture density. Examples of descriptive reservoir property values include facies, lithology (for example, sandstone or carbonate), and environment-of-deposition (EOD). Reservoir properties may be populated into a reservoir framework of computational cells to generate a reservoir model.

A “rock physics model” relates petrophysical and production-related properties of a formation (or its constituents) to the bulk elastic properties of the formation. Examples of petrophysical and production-related properties may include, but are not limited to, porosity, pore geometry, pore connectivity volume of shale or clay, estimated overburden stress or related data, pore pressure, fluid type and content, clay content, mineralogy, temperature, and anisotropy and examples of bulk elastic properties may include, but are not limited to, P-impedance and S-impedance. A rock physics model may provide values that may be used as a velocity model for a seismic survey.

“Shale” is a fine-grained clastic sedimentary rock that may be found in formations, and may often have a mean grain size of less than 0.0625 mm. Shale typically includes laminated and fissile siltstones and claystones. These materials may be formed from clays, quartz, and other minerals that are found in fine-grained rocks. Non-limiting examples of shales include Barnett, Fayetteville, and Woodford in North America. Shale has low matrix permeability, so gas production in commercial quantities requires fractures to provide permeability. Shale gas reservoirs may be hydraulically fractured to create extensive artificial fracture networks around wellbores. Horizontal drilling is often used with shale gas wells.

“Stimulated Rock Volume” (SRV) describes a relatively large formation volume that has experienced increased permeability and associated hydrocarbon production potential through the use of changed in-situ stress (either applied or reduced stress) and strain techniques, such as but not limited to hydraulic fracturing or other related reservoir stimulation or stressing techniques. In one potential SRV scenario, a network of hydraulic fractures could be in communication with fractures that naturally occur in the formation so that the formation volume outside of one specific hydraulic fracture experiences improved reservoir properties.

“Strain” is the fractional change in dimension or volume of the deformation induced in the material by applying stress. Stain is usually denoted by the Greek alphabet The nine components which fully define the strain at a given point are expressed as ᵢⱼ, where i and j each take the values 1,2,3.

“Stress” is the application of force to a material, such as a through a hydraulic fluid used to fracture a formation. Stress can be measured as force per unit area. Thus, applying a longitudinal force f to a cross-sectional area S of a strength member yields a stress which is given by f/S. The force f could be compressional, leading to longitudinally compressing the strength member, or tensional, leading to longitudinally extending the strength member. Stress is usually denoted by the Greek alphabet. The nine components which fully define the stress state at a given point are expressed as ᵢⱼ, where i and j each take the values 1,2,3.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Thermal fractures” are fractures created in a formation caused by expansion or contraction of a portion of the formation or fluids within the formation. The expansion or contraction may be caused by changing the temperature of the formation or fluids within the formation. The change in temperature may change the pressure of fluids within the formation, resulting in the fracturing. Thermal fractures may propagate into or form in neighboring regions significantly cooler than the heated zone.

“Tight oil” is used to reference formations with relatively low matrix permeability, porosity, or both, where liquid hydrocarbon production potential exists. In these formations, liquid hydrocarbon production may also include natural gas condensate.

“Underburden” refers to the subsurface formation below or farther downhole than a formation containing one or more hydrocarbon-bearing zones, e.g., a hydrocarbon reservoir. For example, underburden may include rock, shale, mudstone, or a wet/tight carbonate, such as an impermeable carbonate without hydrocarbons. An underburden may include a hydrocarbon-containing layer that is relatively impermeable. In some cases, the underburden may be permeable. The underburden may be a formation that is distinct from the hydrocarbon bearing formation or may be a selected fraction within a common formation shared between the underburden portion and the hydrocarbon bearing portion. Intermediate layers may also reside between the underburden layer and the hydrocarbon bearing zone.

The “Young's modulus” of a rock sample from a formation is the stiffness of the rock sample, defined as the amount of axial load (or stress) sufficient to make the rock sample undergo a unit amount of deformation (or strain) in the direction of load application, when deformed within its elastic limit. The higher the Young's modulus, the more stress is required to deform it. It is an elastic property of the material and is usually denoted by the English alphabet E having units the same as that of stress, and is given by:

$$E = \frac{μ ( 3 λ + 2 μ )}{λ + μ} .$$

### Overview

Embodiments of the present techniques provide workflows and methods for selecting a treatment for the stimulation of hydrocarbon bearing subterranean formations, or portions thereof, on a large scale, up to stimulating an entire formation at once. The stimulation treatments include fracturing a target formation, such as a hydrocarbon bearing subterranean formation, by applying stress in a zone proximate to the target formation. The application of stress to the zone proximate can indirectly translate a mechanical stress to the target formation and affect a permeability increase within the target formation. The desired permeability increase is effected by creation of a fracture field in the target formation, such as by delamination fracturing during uplifting, down-folding, or other affected movement of the target formation. The desired permeability may also be the result of other types of fracturing, but it is noted that for simplification purposes, all such fracturing and displacements may be referred to herein generally as fracturing.

In an embodiment, a method is described for designing an optimum treatment to maximize productivity enhancement from the target formation by delamination fracturing (D-Frac). In a first embodiment, a fixed treatment volume or treatment energy requirement is assumed, and the treatment parameters are varied to control the delamination extent, rubblization thickness, slip, or permeability enhancement. In a second embodiment, the treatment volume, pressure, or temperature are selected to achieve a desired delamination extent, slip, or permeability enhancement.

In some embodiments, the treatment design can specify the treatment location (areal and depth), method, size (fluid and solids volume), temperature, pressure and number or length of cycles. Further, the method may optimize the treatment to achieve a combination of delamination extent, slip magnitude, rubblization, and fracture conductivity to improve productivity. The optimization utilizes geologic data, empirical correlations for bedding plane strength and fracture conductivity, and numerical or analytical solutions to linear elastic stress changes.

The techniques may be used with any type of hydrocarbon bearing subterranean formation, such as oil, gas, or mixed reservoirs and may also be used to fracture other types of formations, such as formations used for the production of geothermal energy. In exemplary embodiments, the techniques can be used to enhance production of natural gas from unconventional, e.g., low permeability, gas reservoirs.

In embodiments described herein a single wellbore may be used to reach both the zone proximate and the hydrocarbon bearing subterranean formation, or separate wellbores may be used for access to each of the zone proximate and the subterranean formation. Similarly, a set of wells may be used for application of the principles and methods disclosed and provided herein, such as in a field-wide plan that utilizes numerous wellbores to effect the techniques provided herein. The inventive methods and systems provided herein may also be applied using any of a variety of wellbore configurations, such as substantially vertical wells, horizontal wells, multi-branch wells, deviated wellbores, and combinations thereof

In embodiments, the treatment used to change the stress in the zone proximate to the target formation may be performed by increasing a volume of the zone proximate. For example, a volumetric increase may be created in the zone proximate by introducing a stress-inducing force into the zone proximate, such as via hydraulic fluid, explosively generated gases or pressure, thermal expansion, proppant or cuttings introduction, or other means of affecting such forces. The introduced force may be residual and long lasting or maintained such as via hydraulic fluid introduction, or short in duration such as via explosives. Either such action may introduce residual volume increases, even though at least a portion of the volume increase may be lost when the force is removed. The action in the zone proximate is then translated or transferred into the target formation, and a fracture field is created within the subterranean formation.

In embodiments, the treatment used to change the stress in the zone proximate to the target formation may be applied by decreasing a volume of the zone proximate. The decrease in the volume of the zone proximate may effect a reduction in stress and structural support within the zone proximate. This reduction in structural support translates into a corresponding reduction in stability of the hydrocarbon bearing subterranean formation, resulting in creation of a fracture field within the subterranean formation. Examples of effecting a stress reduction in the zone proximate may include freshwater dissolution of salt from a zone proximate, production of water or other fluids from a zone proximate to reduce structural support in the subterranean formation, chemical dissolution of the rock material within the zone proximate, physical removal of portion of the zone proximate, such as via a network of relatively large or under-reamed wellbores within the zone proximate, and similar actions or treatments to reduce structural strength of the zone proximate with respect to the in-situ, pre-treatment, or pre-action strength.

Further, the treatments used to change the stress do not have to involve a volumetric change. The methods described herein may include any number of other techniques that alter the geomechanical stresses of a formation, including external or internal stresses, by dislocation, displacement, strain changes, or fracturing of a zone proximate or subterranean formation, without substantial volumetric change therein. Although a volumetric change is not necessarily involved, the stress can still be communicated from the zone proximate to the targeted subterranean formation. The techniques described herein generally include treating a zone proximate to a target formation to effect a stress change in the zone proximate, which will effect a permeability increase in the target formation.

Further, the application of the stress, e.g., through volumetric changes, does not have to be performed as a single event. In some embodiments, application and removal of the stress and strain on the zone proximate may be cycled to cause subsequent rubblization and fracturing within the subterranean formation. The increased rubblization at fracture surfaces can lead to further improvements in permeability within the targeted formation.

The stress applied to the targeted formation can cause delamination of layers and other forms of non-hydraulic fracturing, leading to the formation of cracks over a broad area. The cracks or fractures may result from a residual or “hysteresis” displacement of the formation components due to the strain displacement that remains, both while the stress is applied and after the stress is relaxed. The hysteresis effect results from the failure of the crack or fracture to heal completely, in the event further fracturing happens and/or the applied stress is reduced. Thereby, the permeability may be at least somewhat permanently improved. Ideally, the stress applied to the target formation creates some residual permeability in at least a portion of the targeted subterranean formation. The treatment duration may range from seconds, such as if explosives are used, to a period of months, such as if waste tailings are used to fracture and prop open the fractures in the zone proximate formation.

At the delaminated fractures, the formation surfaces or rock strata within the formation can be destroyed, forming a rubble layer or interface between the surfaces. Further, the formation surfaces can be offset from their original position, forming open apertures between the surfaces. If the volume changes in the proximate formation are repeated, the rubblization may be increased, forming channels through which natural gas, other hydrocarbons, or heated water, may be harvested. The use of an applied mechanical stress may be considered counterintuitive, since such stresses would normally tend to close fractures or cleats, leading to lower production. However, in exemplary embodiments, the application of stress may provide increased permeability and production rates, due to delamination along weak layers and rubblization within the target reservoir, as mentioned above and discussed in further detail below.

Although shown as being substantially parallel or coplanar with respect to each other in the figures to follow, the zone proximate and the hydrocarbon bearing subterranean formation may be situated in non-parallel planes. The zone proximate and hydrocarbon bearing subterranean formation may also be oriented substantially horizontal, vertical, deviated, folded, originally arched, faulted, or irregularly positioned with respect to the wellbore and each other. Each may comprise a single geologic formation, zone, lens, or structure, or multiple formations, zones, lenses, or structures.

As described herein, the treatment can induce hydraulically conductive delamination fractures (D-Fracs) within the hydrocarbon bearing subterranean formation. In some embodiments, the present techniques can increase well productivity, lessen environmental impact, enhance well integrity and reliability, and improve well utilization and hydrocarbon recovery. Further, production rates and the recovery factor may be enhanced by cyclic “rubblization” over the full formation thickness. In contrast to hydraulic fracturing, which is generally halted by geological drainage boundaries, such as faults and pinchouts, delamination fractures may extend beyond geologic drainage boundaries, thereby reducing the number of wells and associated environmental footprint required for economic development. For example, the delamination may cover an area of about nine times the area of the volumetric expansion, for example, when the strength of the activated bedding plane interfaces are sufficiently low.

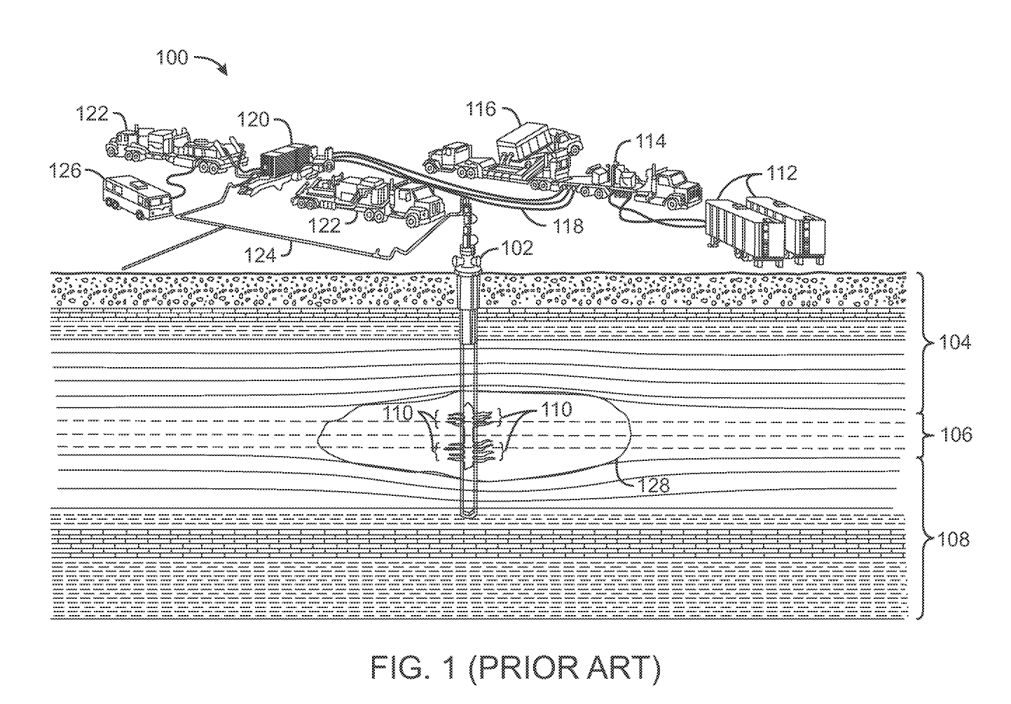

FIG. 1 is a diagram of a hydraulic fracturing process 100. The traditional method of fracture stimulation utilizes “hydraulic” pressure pumping and is a proven technology that has been used since the 1940s in more than 1 million wells in the United States to help produce oil and natural gas. In typical oilfield operations, the technology involves pumping a water-sand mixture into subterranean layers where the oil or gas is trapped. The pressure of the water creates tiny fissures or fractures in the rock. After pumping is finished the sand props open the fractures, allowing the oil or gas to escape from the hydrocarbon bearing formation and flow to a wellbore.

For example, a well 102 may be drilled through an overburden 104 to a hydrocarbon bearing subterranean formation 106. Although the well 102 may penetrate through the hydrocarbon bearing subterranean formation 106 and into the underburden 108, perforations 110 in the well 102 can direct fluids to and from the hydrocarbon bearing subterranean formation 106. The hydraulic fracturing process 100 may utilize an extensive amount of equipment at the well site. This equipment may include fluid storage tanks 112 to hold the fracturing fluid, and blenders 114 to blend the fracturing fluid with other materials, such as proppant 116 and other chemical additives, forming a low pressure slurry. The low pressure slurry 118 may be run through a treater manifold 120, which may use pumps 122 to adjust flow rates, pressures, and the like, creating a high pressure slurry 124, which can be pumped down the well 102 to fracture the rocks in the hydrocarbon bearing subterranean formation 106. A mobile command center 126 may be used to control the fracturing process.

The goal of hydraulic fracture stimulation is to create a highly-conductive fracture zone 128 by engineering subsurface stress conditions to induce pressure parting of the formation in the hydrocarbon bearing subterranean formation 106. This is generally performed by injecting fluids with a high permeability proppant 116, such as sand, into the hydrocarbon bearing subterranean formation 106 to overcome “in-situ” stresses and hydraulically-fracture the reservoir rock. A number of liquids may be sequentially injected to perform the fracturing. Generally, the liquids will be sequentially increased in viscosity until a highest viscosity fluid is used. Any number of other pumping orders and system may be used in embodiments, for example, when fracturing zones proximate to the hydrocarbon bearing subterranean formation.

The fracture zone 128 may be considered a network or “cloud” of fractures generally radiating out from the well 102. Depending on the depth of the hydrocarbon bearing subterranean formation 106, the fractures may often be predominately perpendicular to the bedding planes, e.g., vertical within the subsurface.

After the fracturing process 100 is completed, the treating fluids are flowed back to minimize formation damage. For example, contact with the fracturing fluids may result in imbibement of the fluids by pores in the hydrocarbon bearing subterranean formation 106, which may actually lower the productivity of the reservoir. Further, a carefully controlled flowback may ensure proper fracture closure, trapping the proppant 116 in the fractures and holding them open. The fluids may also be flushed to remove the materials, for example, with a solvent, acid, or other material that can dissolve or break down residual traces of the fracturing fluids.

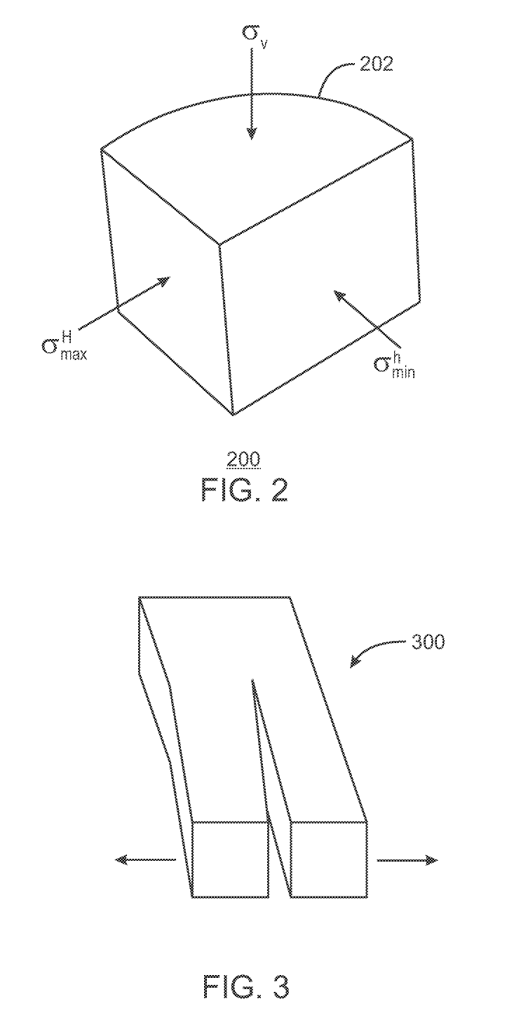

Stimulation is generally effective at near-well scale, for example, in which the fracture dimensions are in the 100s of feet. Treating and production are often conducted in the same interval, e.g., the portion of the hydrocarbon bearing subterranean formation 106 reached by the well 102. The fracturing process 100 may use significant amounts of freshwater and proppant materials. The orientation of the fractures is controlled by the local stresses in the hydrocarbon bearing subterranean formation 106 as discussed further with respect to FIG. 2.

FIG. 2 is a drawing of a local stress state 200 for an element 202 in a hydrocarbon bearing subterranean formation. The state of stress in the earth is defined by the mass of the overburden, the pressure in the pores of the rock, the tectonic stresses governing boundary conditions, and the basic mechanical properties of the rock, such as Elastic moduli or stiffness. The in-situ earth stresses determine the predominant orientation of hydraulic fractures. The presence of natural fractures, the configuration of the completion itself, and the characteristics of the treating fluids may alter the earth stresses near the well and thereby influence growth of hydraulic fractures for a relatively short distance away from the well.

The earth stresses can be divided into three principal stresses where σᵥ is the vertical stress in this drawing, σ^{H}ₘₐₓ is the maximum horizontal stress, and σ^{h}ₘᵢₙ is the minimum horizontal stress. These stresses are normally compressive and vary in magnitude throughout the reservoir, particularly in the vertical direction and from layer to layer. The vertical stress σ_{z}, is typically the most compressive stress, i.e., σᵥ>σ^{H}ₘₐₓ>^{h}ₘᵢₙ. However, depending on geologic conditions, the vertical stress could be less compressive than the maximum horizontal stress, σ^{H}ₘₐₓ, or than the minimum horizontal stress, σ^{h}ₘᵢₙ.

The stresses vary in magnitude throughout the reservoir, particularly in the vertical direction (from layer to layer). The magnitude and direction of the principal stresses are important because they control the pressure required to create and propagate a fracture, the shape and vertical extent of the fracture, the propagation direction of the fracture, and the closure stresses which may lead to crushing and/or embedment of the propping agent during production.

Fractures in a horizontal direction, e.g., perpendicular to a vertically drilled well or parallel to a horizontally drilled well, may be more effective at conducting hydrocarbons back to the well for production. In deeper wells, the higher vertical stress from the overburden may often force fractures to be predominately vertical, e.g., perpendicular to a horizontally drilled wellbore.

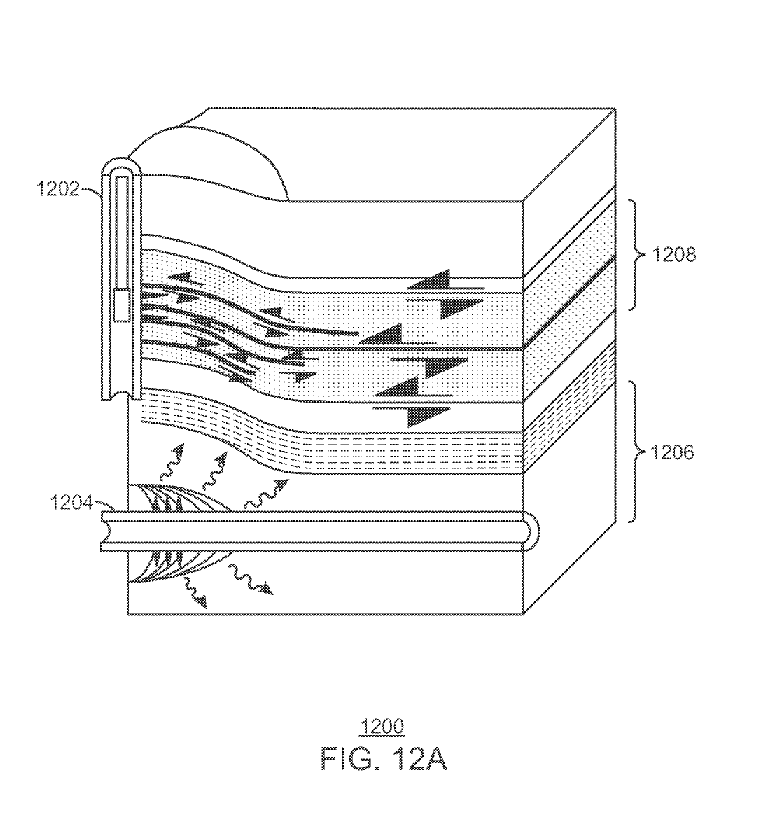

However, other stress conditions may exist in formations, leading to different fracturing patterns. For example, depending on geologic conditions, the vertical stress could be substantially equivalent to the orthogonal lateral stresses. In this condition, termed lithostatic, the direction of a fracture may be controlled by any stress perturbations that take place in the formation. One such perturbation is the wellbore itself, which may favor the formation of vertical fractures. Another perturbation would be the creation of a notch in the formation, as discussed with respect to FIG. 11. The notch may favor the creation of horizontal fractures in the formation, although a fracture may form in a horizontal direction, then turn in a vertical direction after some distance through the formation.

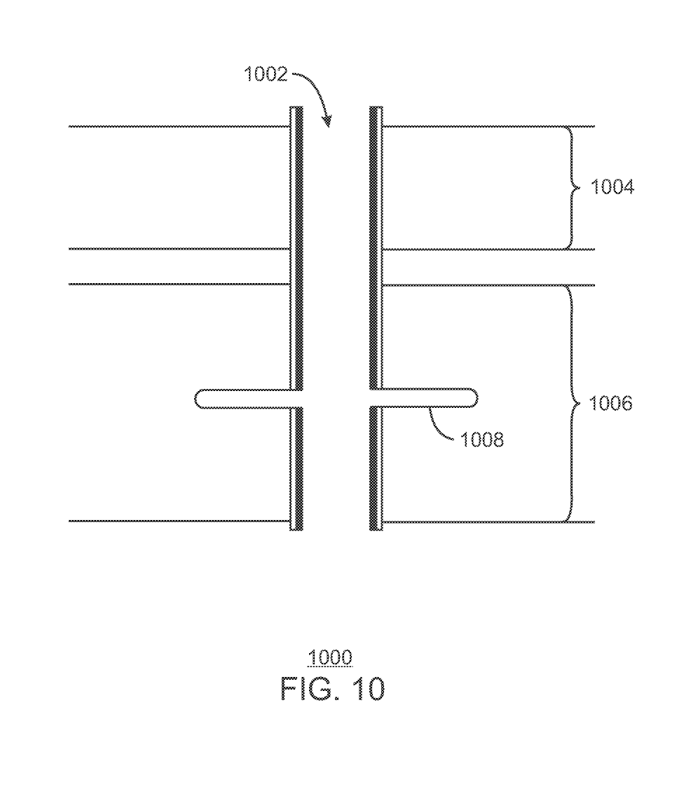

In another condition, the formation may be formed from a rock that is orthotropic. In this case, the rock itself is formed along planar layers that favor the formation of fractures along the planes. If the planes are parallel to the surface, the formation will have an increased tendency to form horizontal fractures, even under high vertical stress. As another example, a formation may be overpressured, in which the formation has a high pore pressure. Under this condition, the high pore pressure may have a tendency to offset a high vertical stress, allowing the fracturing to be controlled by the addition of stress perturbations in the formation. Generally, as the pressure in the hydrocarbon bearing subterranean formation drops, for example, during production, further fracturing may be horizontal due to reorientation of the stresses. This is discussed in further detail with respect to FIG. 9. The stresses may also be adjusted to favor the growth of horizontal fractures, as discussed with respect to FIGS. 9-11.

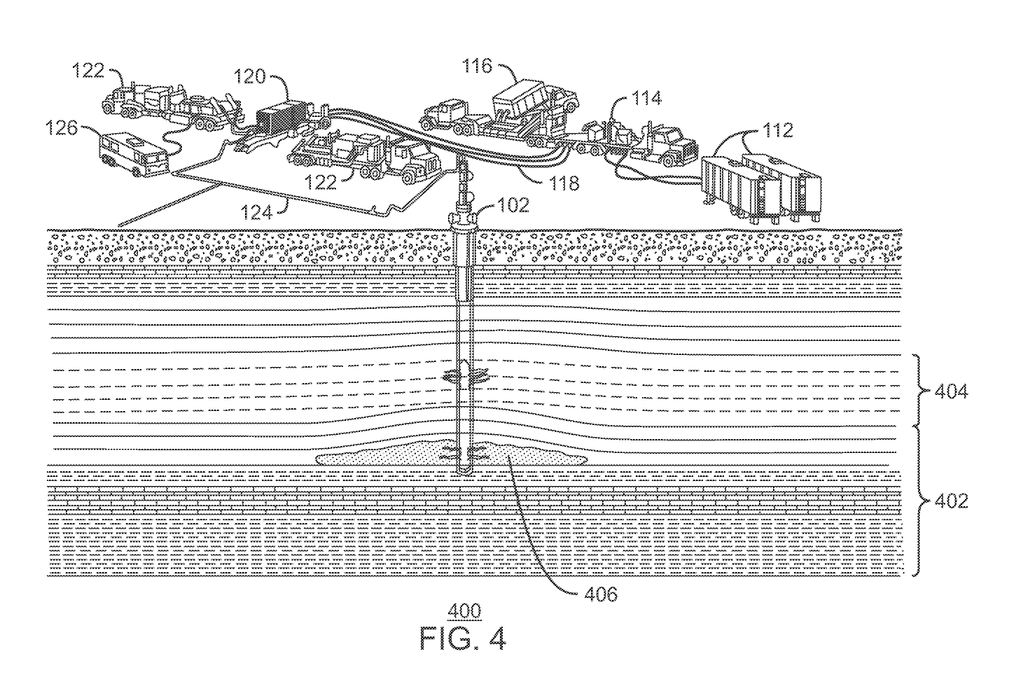

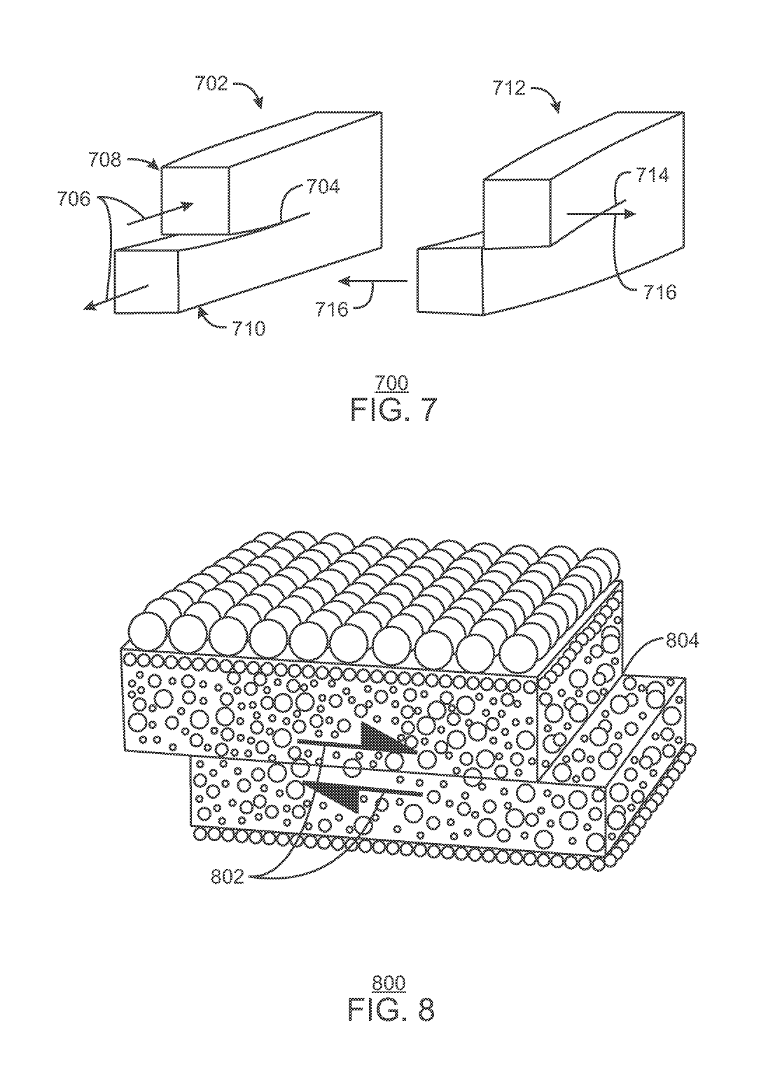

FIG. 3 is a drawing of a first mode (mode I) 300 of fracture formation, commonly resulting from a standard hydraulic fracturing process. Fractures generally propagate in one or more of three primary modes as discussed with respect to FIGS. 3 and 7. While, each mode is capable of propagating a fracture, standard hydraulic fracture stimulation predominantly utilizes mode I 300, resulting from “direct” fluid pressure parting of the formation. In mode I 300, the pressure of the hydraulic fracturing fluid either creates fractures, opens, or propagates pre-existing fractures. The fractures are propagated by tensile breaking of the rock of the formation at the crack tip.

As noted herein, the fractures may often be nearly vertical and approximately perpendicular to bedding planes. At shallow depths, the fractures produced may be horizontal, in which case they likely will be parallel to bedding planes. In standard hydraulic fracturing, the hydraulic pressure and fluids directly contact the formation being fractured or treated. Application of the traditional hydraulic fracturing method to unconventional hydrocarbon resources, such as tight gas or shale gas reservoirs, requires both large numbers of wells and large numbers of fracture treatments in each well. These requirements are largely driven by the relatively small “effective” area that is created during the hydraulic fracturing process due to inherent limitations in the treating fluids, proppants, reservoir stratigraphy, and in-situ stresses. In some embodiments of the present techniques, a volumetric change in a layer adjacent to the hydrocarbon bearing subterranean formation can be used to place or relieve a stress on the reservoir, leading to fracturing in the reservoir. The volumetric change may be an increase or a decrease of the zone.

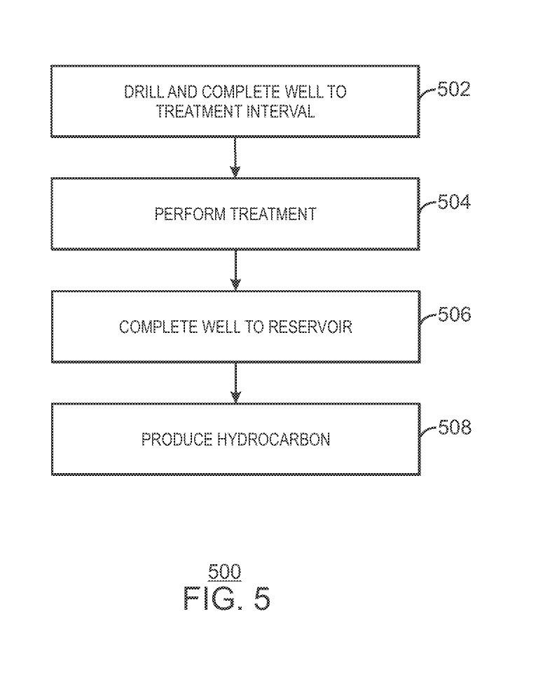

FIG. 4 is an exemplified drawing of a well treatment system such as a hydraulic fracturing system 400, wherein a zone 402 below a hydrocarbon bearing subterranean formation 404 is subjected to a volumetric expansion 406, which can place stress on the hydrocarbon bearing subterranean formation 404 leading to fracturing. The techniques are not limited to a hydrocarbon bearing subterranean formation 404, but may be used in any number of situations where fracturing a formation layer would be useful, such as in the production of geothermal energy. In the hydraulic fracturing system 400, all like units are as discussed with respect to FIG. 1. In this embodiment, the drilling and production wastes from the field may be used for the hydraulic fracturing of the zone 402, lowering the requirements for freshwater over standard hydraulic fracturing. Further, the drilling cuttings may be used to provide a proppant to maintain the fractures open in the zone 402. The present techniques are not limited to hydraulic fracturing of the zone 402. In embodiments, thermal expansion may be used to create the volumetric expansion 406. Further, a pressurized liquid may be used to cause the volumetric expansion 406 of the zone 402 without fracturing. The volumetric expansion 406 may be cycled by various techniques, such as successive thermal heating and cooling cycles, or successive fluid injections and removal cycles.

In other embodiments, a volumetric contraction may be used in place of the volumetric expansion 406. For example, chemical treatment may be applied in the zone 402 to create an area of cavitation around the well 102, such as by using an acid to remove a portion of the zone 402. In some embodiments, the volumetric contraction may be provided through production of fluids from the non-hydrocarbon producing zone 402 to create subsidence in both the non-hydrocarbon-bearing zone and in the adjacent hydrocarbon bearing subterranean formation 404. Further, a separate borehole could be drilled in the zone 402 to induce the volumetric contraction. The effects of volumetric contraction may be enhanced by alternately injecting and then producing fluid in successive cycles, for example, over hours, days, weeks, months, or even years.

In other embodiments, a stress may be imposed on the zone 402 without substantially increasing or decreasing the volume of the zone 402. The stress imposed on the zone 402 may induce a corresponding stress state on the hydrocarbon bearing subterranean formation 404.

In some embodiments, the formation layers of interest are mechanically damaged or “delaminated,” for example, by arching, or bending flexure, of the hydrocarbon bearing subterranean formation 404. The method used to treat the hydrocarbon bearing subterranean formation 404 would need to create a stress state sufficient to impose delamination fracturing along preferred layers of interest. This may occur from dilating formations in the zone 402 from below, creating an uplift in the hydrocarbon bearing subterranean formation 404.

The delamination fractures may be created without pressurizing the fracture surfaces of the hydrocarbon bearing subterranean formation 404 with treating fluids. As stimulation fluids do not need to contact the surfaces of the formation, the hydrocarbon bearing subterranean formation 404 may not be damaged by imbibement of the treating fluids. The stimulation may be effective at reservoir scale, i.e., the fracture dimensions may be on the order of 1000s of feet. Further, the treating and the production may be conducted in different intervals, using the same or separate wells.

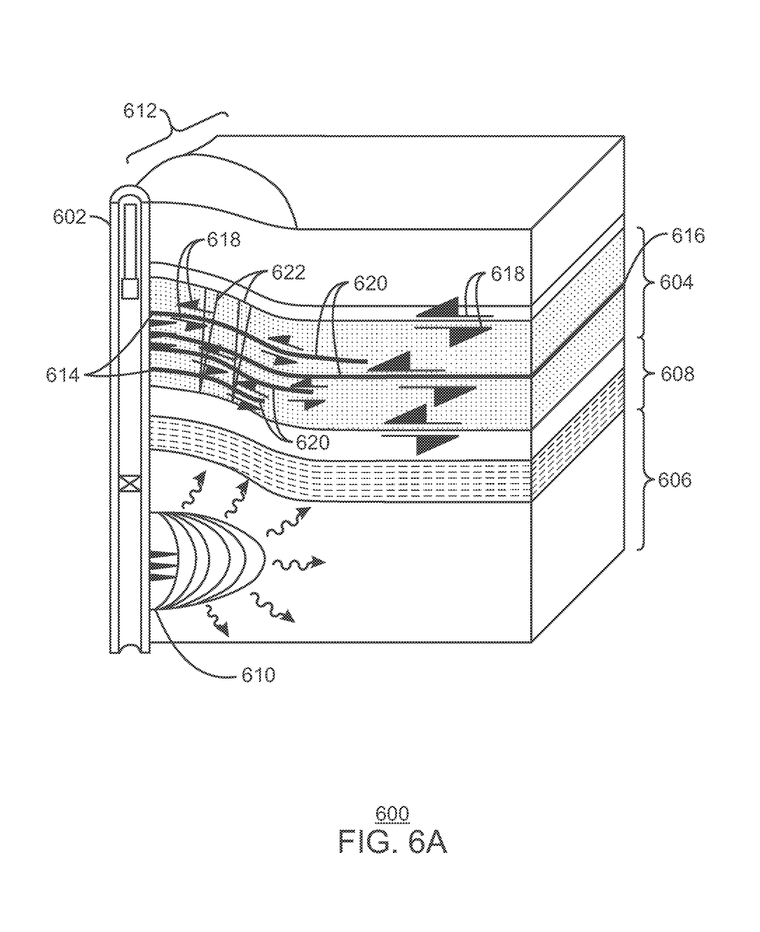

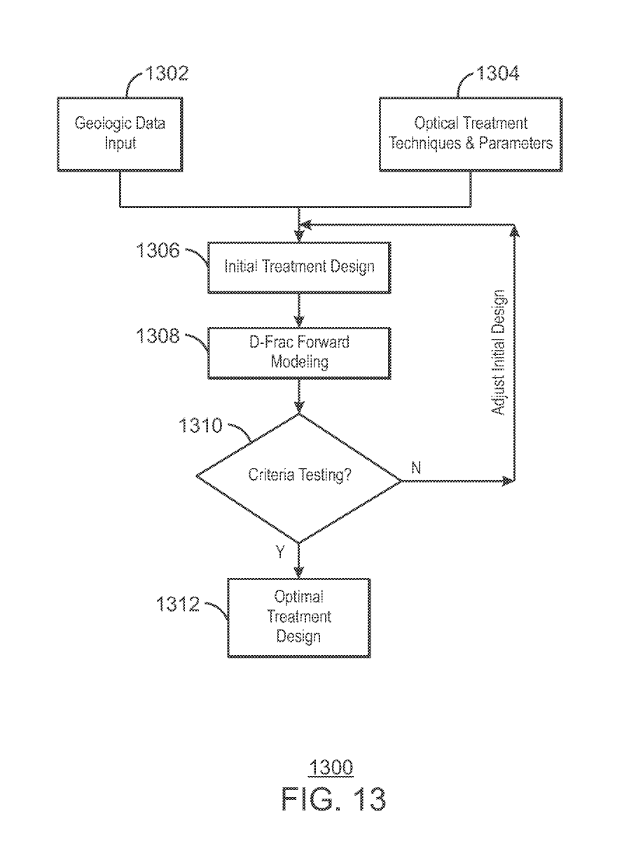

FIG. 5 is a block diagram of a method 500 for stimulation of a hydrocarbon bearing subterranean formation by treating a formation outside of the reservoir. In embodiments, the treatments used can be identified by the methods described with respect to FIGS. 13-15. The method 500 begins at block 502, with the drilling and completing of a well to the treatment interval. The treatment interval may be a zone 402 located under the hydrocarbon bearing subterranean formation, as generally discussed with respect to FIG. 4. In other embodiments, the treatment interval may be beside or above the hydrocarbon bearing subterranean formation, for example, if the hydrocarbon bearing subterranean formation is in a deviated formation. At block 504, the treatment interval is treated, such as by a chemical, thermal, physical, biological, or other treatment. For example, fracturing fluids may be injected into the treatment interval. The fracturing fluids may or may not include solids for proppants, such as crushed drilling cuttings from wells. In some embodiments, the treatment may be performed by successively inflating and deflating the treatment interval to cause rubblization of the hydrocarbon bearing subterranean formation. The treatment may be performed by increasing underburden support and/or pressure to deflate a zone 402 and then providing an expansive force such as pressure or a heat source into the treatment interval to reinflate the treatment interval. Such deflation and inflation may be cyclically performed.

At block 506, a production well is completed to the reservoir to produce hydrocarbons. The production well may be drilled after stimulation from the treating well, thereby reducing the potential for subsequent well integrity or reliability issues. In embodiments, the production well may be the same as the treatment well, for example, by creating perforations in the well at the interval of the hydrocarbon bearing subterranean formation, or by drilling production wells from the treatment well. The production well may be fluidically coupled to a more remote fracture field by fracturing within hydrocarbon bearing subterranean formation.

At block 508, hydrocarbons may be produced from the production well. It will be clear that the techniques described herein are not limited to the production of hydrocarbons, but may be used in other circumstances where a subterranean formation is fractured to aid in the production of fluid. For example, in embodiments, the techniques may be used to fracture a hot dry formation layer for use in geothermal energy production. Water or other fluids may then be circulated through the fractures, collected in a production well, and returned to the surface for harvesting heat energy. The wells are not limited to the conformations discussed above. In embodiments, various treating, and producing well patterns and operational schemes may be considered to concurrently optimize reservoir stimulation, gas production, waste disposal, and well operability.

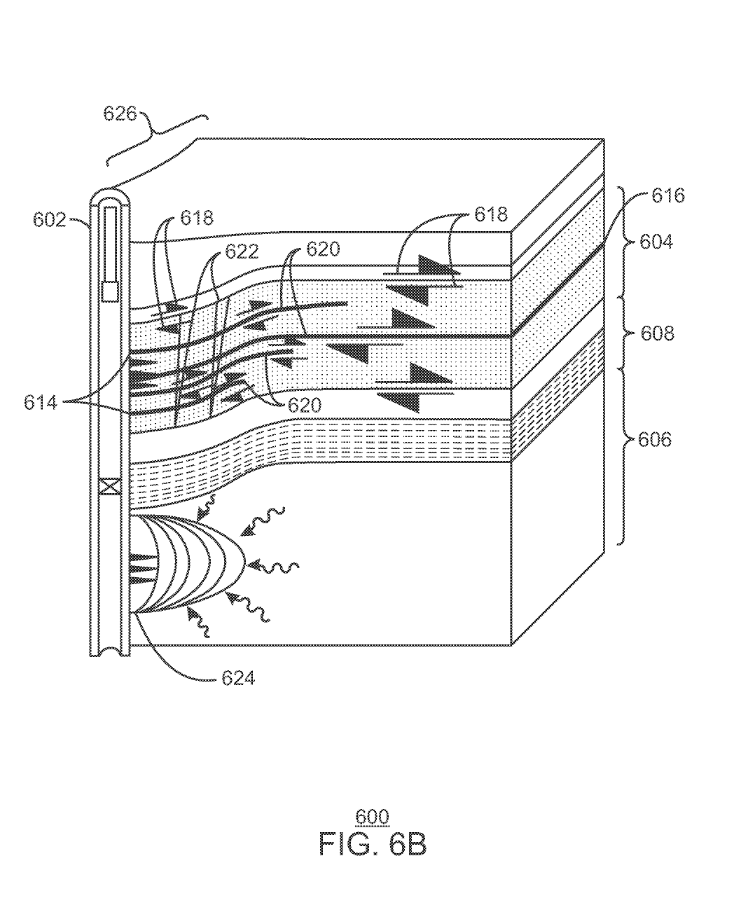

FIG. 6A is a more detailed schematic view of a delamination fracture stimulation performed by inflating a zone proximate to a production zone. A well 602 may be drilled through a hydrocarbon bearing subterranean formation 604, and into a treatment interval or zone 606 below the hydrocarbon bearing subterranean formation 604. The treatment interval or zone 606 does not have to be adjacent to the hydrocarbon bearing subterranean formation 604, but may have one or more intervening layers 608. These layers 608 may lower the chance that a treatment fluid, if used, will leak into the hydrocarbon bearing subterranean formation 604. Further, if waste tailing are used as proppants, the layers 608 may assist in fixing the tailings in place, lowering the probability that material may migrate into the hydrocarbon bearing subterranean formation 604 or other locations, such as aquifers.

As the treatment progresses, a volumetric expansion 610 occurs in the treatment interval or zone 606, which presses upwards on the layers 608, forming an arch or dome 612 in the hydrocarbon bearing subterranean formation 604. In the embodiment shown, fluids and/or particulate solids are injected into the treatment interval or zone 606 to dilate, uplift, “arch,” and shear fracture the hydrocarbon bearing subterranean formation 604. The distance, or vertical distance, between the zone 606 and the hydrocarbon bearing subterranean formation 604 may control the size of the area over which the treatment affects the hydrocarbon bearing subterranean formation 604. A layer that is further from the hydrocarbon bearing subterranean formation 604 may affect a wider area, but with a lower total movement or rubblization. For example, if a treatment of a zone 606 located around 50 m under the hydrocarbon bearing subterranean formation 604 caused a vertical motion of about 2 cm over a distance of about 500 m, treatment of a zone 606 located about 100 m under the hydrocarbon bearing subterranean formation 606, using the same contraction and/or expansion conditions, may cause a vertical motion of about 1 cm over a horizontal distance of about 1000 m.

Further, the arch or dome 612 may have a highest stress region, e.g., the area in which the fractures form within the hydrocarbon bearing subterranean formation 604, that is not centered on the injection well 602. As the distance between the volumetric expansion 610 and the hydrocarbon bearing subterranean formation 604 increases, so does the distance between the well 602 and the highest stress point in the hydrocarbon bearing subterranean formation 604. Accordingly, if the highest stress point in the hydrocarbon bearing subterranean formation 604 is sufficiently separated from the well 602, fracturing of the hydrocarbon bearing subterranean formation 604 may be used to couple the fracture field around the highest stress point with the well 602.

In addition to separation distance, the choice of the treatment zone 606 may be made on the basis of formation properties, both in the zone 606 and in the hydrocarbon bearing subterranean formation 604. A relatively impermeable formation may be useful for treatment using hydraulic fracturing techniques, as the zone 606 may have lower leak-off, making the treatment more efficient. If waste tailings are going to be used, this may be less of an issue, as the zone 606 may be propped open and expanded, even after pressure has leaked off If thermal expansion is going to be used, the zone 606 may be selected to have a higher coefficient of thermal expansion than other surrounding zones.

In addition to the properties of the formation within the zone 606, the properties of the material in the hydrocarbon bearing subterranean formation 604 may also influence the choice of expansion techniques and location. For example, if the hydrocarbon bearing subterranean formation 604 is shale, a slow expansion may not open sufficient cracks, as a ductile shale may have enough plastic deformation to reseal the cracks. Thus, an explosive deformation may cause a fast enough deformation, such as on the order of seconds, to shatter the shale without plastic flow resealing the cracks. In this case, the zone 606 may be selected to have a hard rock, such as granite, that can transfer the energy of expansion to the hydrocarbon bearing subterranean formation 604.

A hydrocarbon bearing subterranean formation 604 may often have weaker layers 614, or even inherent fracture planes 616. The arching can cause shear stress in the hydrocarbon bearing subterranean formation 604, leading to sliding or breaking of the hydrocarbon bearing subterranean formation 604 along these layers 614 and fracture planes 616, as indicated by the arrows 618, creating delamination fractures 620. Thus, the delamination fracture stimulation 600 can create a highly-conductive multi-fracture/dual-porosity reservoir system by delaminating formation layers, parting formation within layers, and rubblizing the formation “in-situ.” The injection operations may also create relative movement or displacement between the fracture surfaces along the layers 614 and fracture planes 616 to achieve fracture conductivity, for example, by creating delamination fractures 620 that contain enhanced permeability formation debris. Vertical fractures 622 may also be created during the delamination process. The control of stresses in the formation may be used to control the direction of the fractures, as discussed with respect to FIGS. 9 to 11.

In addition to the injection of fluids, embodiments may induce delamination fractures in the hydrocarbon bearing subterranean formation 604 using in-situ techniques, such as thermal heating, explosive detonations, and the like to enlarge the volume of the treatment interval or zone 606 and thereby increase the stresses at the target formation intervals such that shear-dominated fractures delaminate along, and possibly normal to, the bedding planes.

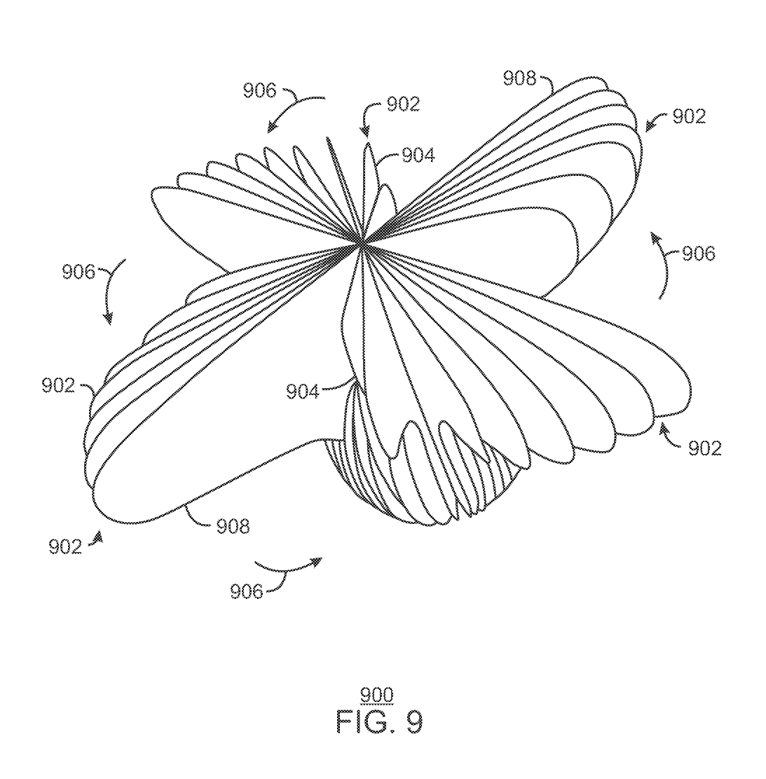

The flow conductivity of the delamination fractures may be enhanced by cyclically inflating and deflating the treatment interval or zone 606 such that the delaminated formations “rubblize” due to frictional contact and relative sliding motion between formation surfaces, creating an in-situ propped bed of failed formation material. This is discussed further with respect to FIG. 8.

In contrast with the direct hydraulic fracture stimulation of a hydrocarbon bearing subterranean formation 604, the delamination fracture stimulation 600 minimizes direct fluid contact with the formation fracture face, thereby reducing the potential for formation damage and the need for flowback clean-up. Further, fracture “conductivity” is created in-situ over the full fracture dimensions, thereby enhancing productivity and eliminating the need for transporting proppants. The fractures 620 may also extend beyond geologic drainage boundaries, such as faults, pinchouts and the like, reducing the number of wells required for economic development. The fracture delamination may be created using “waste disposal” products, such as drill cuttings, produced brines, and the like, to enhance volumetric strain, reducing the need for customized fracturing formulations and large volumes of freshwater. The fracture delamination or other permeability improvement also may be created with non-aqueous techniques to enhance volumetric strain, reducing the need for customized fracturing formulations and large volumes of freshwater.

In summary, the delamination fracture stimulation 600 is based on three physical components, including delamination, rubblization, and stress control. The relative importance of each of these components is dependent on the parameters of the particular application, for example, the depths of treatment interval or zone 606 and hydrocarbon bearing subterranean formation 604, the thicknesses of each interval 604 and 606, the formation properties, the pore pressures, the in-situ stress environments, and the like.

FIG. 6B is a more detailed schematic view of a delamination fracture stimulation performed by deflating a zone proximate to a production zone. As described herein, the changes to the zone 606 are not limited to inflation. In FIG. 6B the zone 606 is deflated, causing a volumetric contraction 624. As described herein, the volumetric contraction 624 may be caused by a physical effect, such as a temperature change or the removal of fluids from the zone 606, or by a chemical effect, such as acid dissolution of the rock in the zone 606. The volumetric contraction 624 may have a corresponding subsidence 626 at the surface. Although the volumetric contraction 624 is in the opposite direction from a volumetric expansion 610 of FIG. 6A, the physics of the delamination process will be similar.

FIG. 7 is a drawing 700 of two modes of fracture formation that may participate in delamination fracture stimulation as discussed herein. Both of these modes are based on shearing the rock, rather than tensile parting of the rock. An in--plane shear mode 702 develops a fracture 704 that is aligned (i.e., in the same two-dimensional plane) with the applied shear stress 706. The in-plane shear mode 702, also termed mode II, may develop as an arch or bend that distorts a reservoir. Further, the in-plane shear mode 702 may develop horizontal fractures, for example, as some layers 708 are placed under compressive stress, while other layers 710 are released from compressive stress. Additional mode I 300 “non-hydraulic” tensile fractures also may be incurred from stress arching of the reservoir. Another mode of fracture formation is an anti-plane shear mode 712, also termed mode III. Similarly, the anti-plane shear mode 712 develops a fracture 714 that also is aligned in the same two-dimensional plane with the applied shear stress 716. This mode may also participate in both vertical and horizontal fractures as adjacent layers are moved in opposite directions. In embodiments, both mode II 702, and mode III 712, or any combinations thereof, may propagate damage and fractures perpendicular or parallel to bedding planes through the use of a volumetric increase in layers outside of a reservoir interval. The shearing modes may cause material to disaggregate forming a rubble layer.

FIG. 8 is a drawing of rubblization 800 during shearing 802 at a fracture boundary 804. Direct hydraulic fracturing of a reservoir generally causes tensile fracturing of reservoir rocks as discussed with respect to mode I shown in FIG. 3. In contrast, the shearing 802 that takes place in embodiments, as discussed with respect to FIG. 7, can force formation surfaces to slide against each other at a bedding plan interface or fracture boundary 804. Frictional engagement of features on the surfaces may cause the formation to break, leading to the formation of a rubblized layer within or adjacent to the fracture boundary 804.

As mentioned previously, the flow conductivity of delamination fractures may be enhanced by cycling the induced flexures such that the delaminated formations “rubblize” within or adjacent to the fracture boundaries 804 due to frictional contact and relative movement between formation surfaces. This process may create a propped bed of failed formation material in-situ. Based on measurements of formation debris fields created during movements of faults, the thickness of the rubblized zone adjacent to the delamination fractures may up to about 20% of the cumulative linear or transverse movement of the fracture surfaces. Although the amount of formation debris created may be lower with each subsequent cycle, significant porosity may be created in fracture debris zones through the cyclic movement. The failed formation is referred to herein as Cyclic Rubblized Material (“CRM”). CRM results in secondary permeability, i.e., dual permeability and porosity. Stress Distribution and Rearrangement

FIG. 9 is a drawing of an azimuthal rotation 900 of fracture planes 902 within a formation that may occur as a result of cyclic treatment of the formation. The in-situ earth stresses determine the predominant orientation of hydraulic fractures. At shallow depths, hydraulic fractures generally are horizontal and easily create arching, uplift and delamination fractures in formation layers above. However, at deeper depths, hydraulic fractures generally are vertical and the horizontal stresses must be increased to locally re-orient hydraulic fractures.

As discussed above with respect to FIG. 2, the earth stresses can be expressed as three principal stresses. In this case, σᵥ is the vertical overburden stress and is often initially the highest stress in the system. Further, σ^{H}ₘₐₓ is the maximum horizontal stress, while σ^{h}ₘᵢₙ is the minimum horizontal stress, where σᵥ>σ^{H}ₘₐₓ>σ^{h}ₘᵢₙ. Although, at all depths, injection of fluids creates volumetric increases due to pore dilation or formation thermal expansion, the initial fracture plane 904 that forms within the treatment zone may be vertical, which may not place an effective amount of stress on the hydrocarbon bearing subterranean formation. Specially engineered stress conditions may shift the position of the overburden stress to become the intermediate (σ^{H}ₘₐₓ>σᵥ>σ^{h}ₘᵢₙ) or minimum stress (σ^{H}ₘₐₓ>σ^{h}ₘᵢₙ>σᵥ), especially in regions near the well. For example, the engineering of the stress conditions may be performed by sequentially fracturing and propping the formation, leading to an increase in horizontal stresses. As the horizontal stresses dominate the vertical stresses, the fracture planes will rotate into the horizontal.

As a result, the axis of each successive fracture plane 902 in a cyclic fracturing process may be slightly shifted or rotated from the last fracture plane 902, as indicated by an arrow 906. This may continue until a final fracture plane 908 may be horizontal. Fracture re-orientation is dependent on the characteristics of the pumping treatment (i.e., fluid rheology, temperature, pressure, rate, solids content, treatment duration, shut-down schedule), and generally occurs initially about the “azimuth” axis and subsequently about the “inclination” axis until turning horizontal. The technique shown in FIG. 9 may be used in any embodiments, in which stress is changed in the zone proximate to the target formation, including a volume expansion of the zone proximate or a volume decrease in the zone expansion.

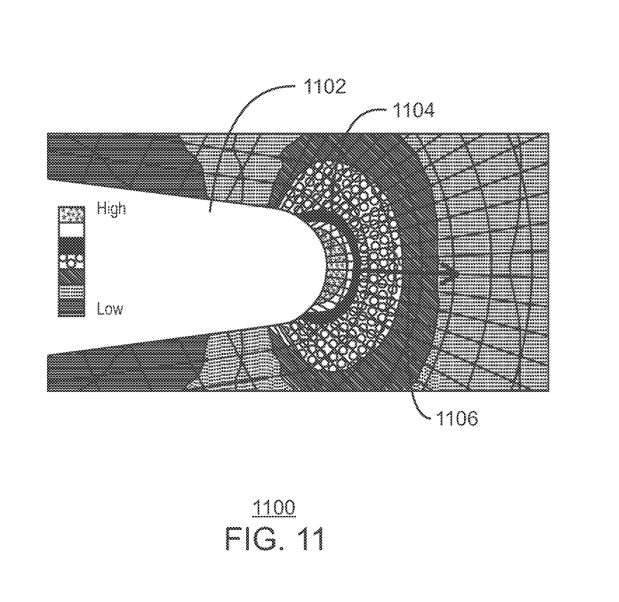

Although the technique discussed with respect to FIG. 9 will increase stress in the formation and rotate the fracture plane to generate horizontal fractures, it will take a number of cycles of inflation and deflation to perform the rotation. Other techniques may be used to initiate horizontal fracture in a faster timeframe, as discussed with respect to FIGS. 10 and 11.

FIG. 10 is a drawing 1000 of a well 1002 passing through a reservoir interval 1004 and a treatment interval 1006, in which a notch 1008 has been formed in the treatment interval. The notch 1008 is a carved indentation in the treatment interval 1006 that creates a stress increase at the tip, promoting the growth of a horizontal fracture 1010. The notch 1006 can be created using any number of down hole tools, such as a jet drilling tool. The notch 1006 can also be created using any number of other techniques, such as a short acid wash to create a wormhole in the treatment interval 1006. The notching is not limited to the treatment interval 1006, but may also be performed in the reservoir interval 1004 to promote the growth of a horizontal fracture.

FIG. 11 is a drawing 1100 of the stress distribution in the formation around the tip of a notch 1102. As can be seen in FIG. 11, the notch 1102 creates a high stress region 1104 at the tip, facilitating an origination of a crack which propagates out in a perpendicular direction 1106 from a well 1108. This technique may also be used in the hydrocarbon bearing subterranean formation to enhance the growth of horizontal fractures that may be used to couple the well to a fracture field.

Well Configurations

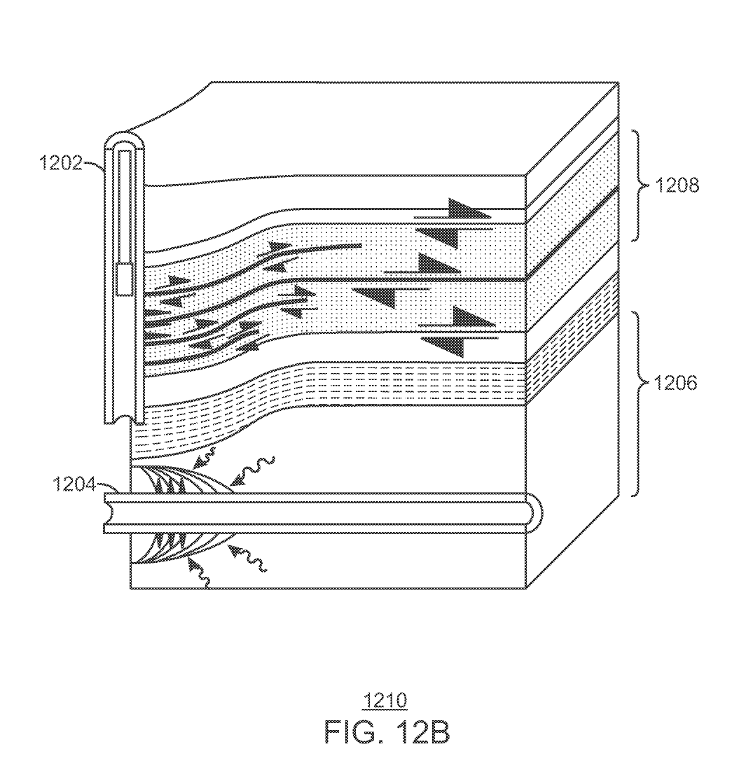

FIG. 12A is a drawing of a delamination fracturing process 1200 illustrating the use of a separate production well 1202 and treatment well 1204 to cause an inflation of the zone 1206. In some embodiments, the treatment interval or zone 1206 may be accessed by one or more treatment wells 1204 other than the production well 1202 accessing the reservoir interval 1208. Furthermore, more than one treatment well 1204 may be utilized to achieve a desired degree of stimulation in a production well 1202. Similarly, more than one production well 1202 may be utilized for a single treatment well 1204. Further, various combinations of treatment wells 1204 and production wells 1202 may be located in sufficient proximity to create synergistic enhancement in their interactions.

FIG. 12B is a drawing of a delamination fracturing process 1210 illustrating the use of a separate production well 1202 and treatment well 1204 to cause a deflation of the zone 1206. In a similar manner to the configuration shown in FIG. 12A, two wells may be used to decrease the volume of a region in the zone 1206.

FIG. 13 is a method 1300 for generating a design for a treatment using stress applied to a treatment interval to place stress on a reservoir interval. The method 1300 begins at block 1302 with the collection of geological data. At block 1304, treatment techniques that may be used to affect a change in a specific type of treatment interval are identified. At block 1306, the potential effects of the different treatments on the treatment interval are explored using numerical modeling. At block 1308, a forward modeling of the effects on a hydrocarbon bearing subterranean formation is performed using empirical bedding strength relationships to determine the resulting delaminations and permeability enhancements. The method 1300 depends on determining the maximum delamination extent and/or permeability enhancement due to change in horizontal and/or vertical stresses for each treatment over the depth range of potential treatment intervals. One such rapid procedure has been developed to determine stress reduction and delamination extent based on a non-dimensional analysis of elastic stress changes due to various treatment methods, as discussed in more detail below.

At block 1310, the treatment is adjusted and the analyses are repeated until criteria such as delamination extent, slip and permeability meet required levels. The criteria that may be used include evaluating potential D-Frac fracture conductivity by using a core-calibrated relationship between permeability and D-Frac stress, rubblization extent, and slip for each treatment type. The permeability enhancement due to reduction of compressive stresses within the reservoir interval may be evaluated using relationship between stress and joint aperture. In an embodiment, reservoir simulations may be performed to evaluate ultimate recovery associated with each treatment. As another criterion, the energy consumed by each treatment may be evaluated based on treating temperature, pressure, injected volume, and the like.

If, at block 1310, the criteria for the treatment have reached the required levels, the recommendation may be made at block 1312. The optimum treatment type may have a depth and magnitude determined at the previous blocks that maximizes productivity, measured as a combination of fracture conductivity, rubblization extent, reservoir permeability enhancement, and ultimate recovery, while meeting energetic, economic and feasibility constrains

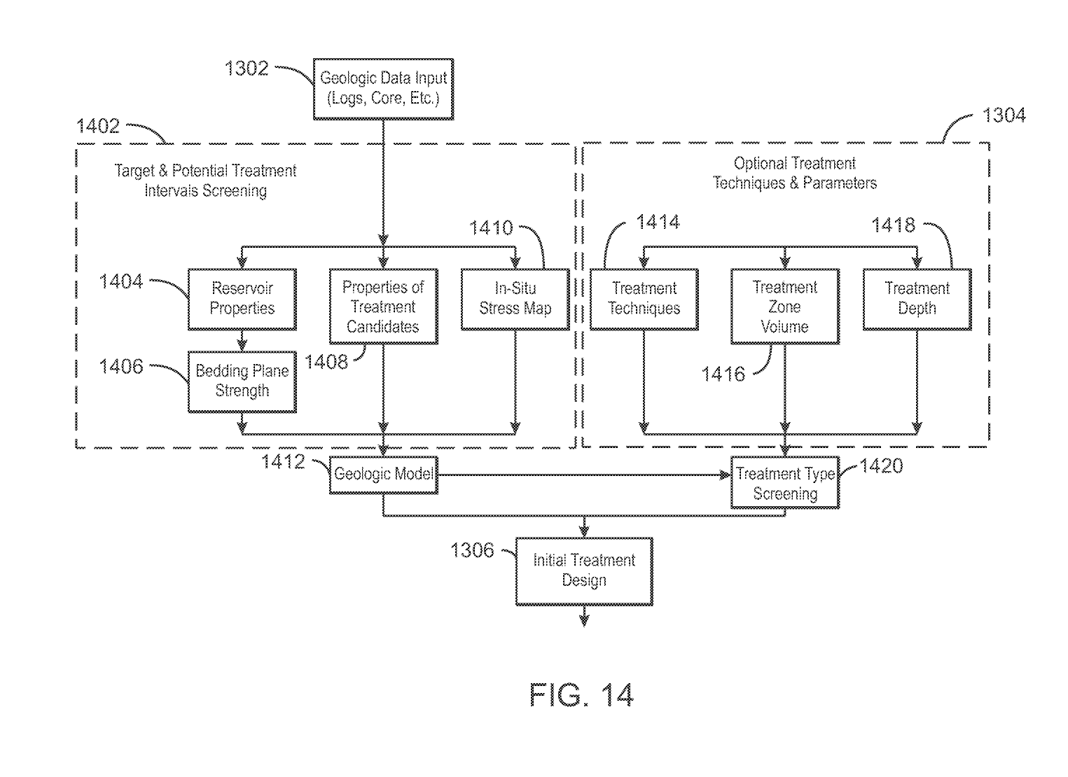

FIG. 14 is a more detailed view of a method for generating the initial treatment design 1306 of the workflow. At block 1402, the initial geologic data used as input to the treatment design is collected. The geologic data can be used to identify target intervals, e.g., hydrocarbon bearing subterranean formations, and potential treatment intervals, e.g., formations adjacent to and below the target intervals. For example, at block 1404, reservoir properties and samples may be collected from the target intervals and potential treatment intervals. The reservoir properties may include well logs, cores, geologic structure, reservoir quality, and stratigraphic data among others. At block 1406, samples collected from the reservoir may be used to determine the bedding plane strength (i.e., friction coefficients and cohesion, and other fracture properties of the hydrocarbon bearing subterranean formation. The bedding plane strength may be useful for identifying candidate locations for delamination.

At block 1408, the properties of the potential treatment intervals may be determined. Such properties include treatment zone volume and treatment depth, among others. Core samples from the treatment interval may be used to determine fracture strength, porosity, liquids content, and the like. At block 1410, an in-situ stress map, σᵢⱼ⁰(x,y,z), may be generated for the reservoir interval, the treatment interval, or both, based on tectonic setting, borehole breakouts, and the like. Once the information has been collected at block 1402, at block 1412 it may be entered into, or used to create, a geologic model. The geologic model may be a small model created to optimize the treatments, or may be part of a larger model for a hydrocarbon field that is used, for example, for seismic imaging, reservoir simulations, and the like.

At block 1304, treatment techniques may be identified. At block 1414, treatment techniques that may be used with the properties of the treatment candidates may be identified. For example, such treatments may include poroelastic expansion of a treatment interval without fracturing, fracturing and expansion of the treatment interval, thermal expansion, explosive expansion and the like. Similarly, treatments may include liquids removal leading to contraction, acidic treatments to dissolve formation rock, thermal contraction, and the like. The treatment properties considered for the initial selection include treatment techniques. Notching of formations within the treatment interval or the production interval may be considered to influence the horizontal growth of cracks. This may be coupled with the determination of the properties of the treatment candidates determined at block 1408. At block 1416, the volume of the treatment zone may be determined. This may include the thickness of a treatment interval and the areal extent of the treatment interval. At block 1418 the depth of the treatment interval, for example, below the hydrocarbon bearing subterranean formation and below the surface may be determined

At block 1420, a treatment screening may be performed based on the geologic model and potential treatment techniques. For example, the candidate treatment types may be screened based on elastic, poroelastic, and thermoelastic properties, in-situ stresses, depths, and the like, to determine the initial treatment design at block 1306.

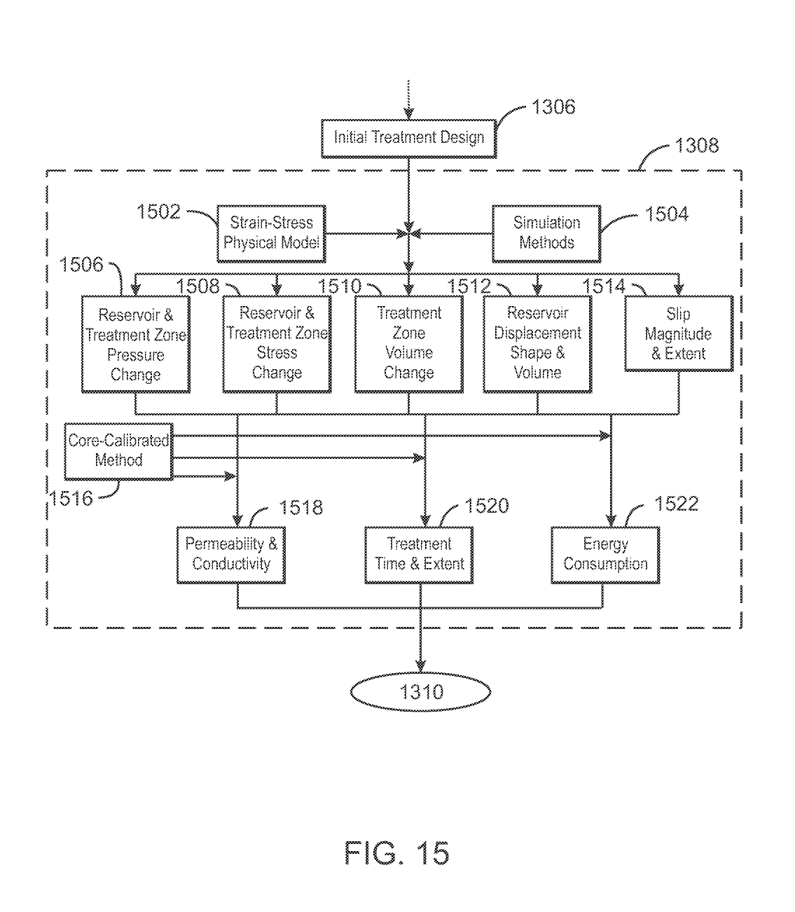

FIG. 15 is a more detailed view of a method for performing the delamination fracture (D-Frac) forward modeling. The D-Frac modeling will use physical stress-strain deformation models 1502 together with numerical simulation methods 1504 to solve for changes in stress, volume, and displacements and predict bedding plane slip. For example, at block 1506 pressure changes that take place in the reservoir interval and treatment interval can be determined At block 1508 stress changes that take place in the reservoir interval and treatment interval can be determined. At blocks 1506 and 1508, volumetric strain changes that take place in the reservoir interval can be determined At block 1510, volume changes that take place in the treatment interval can be determined. At block 1512, the displacement shapes and volumes that take place in the reservoir interval can be determined At block 1514, the slip magnitude and extent that occurs in the reservoir interval can be determined.

The results determined in blocks 1506-1514 can be combined with core calibrated relationships (block 1516) at block 1518 to evaluate reservoir permeability and fracture conductivity after the treatment. Further, the results can be used at block 1520 to determine treatment time and extent and, at block 1522, to determine the resulting energy consumption. These results for each treatment can be passed to block 1310, which performs the criterion checking and either passes on the matching recommendation or starts a new iteration of the modeling.

Application of Modeling Methods to Determine Treatments

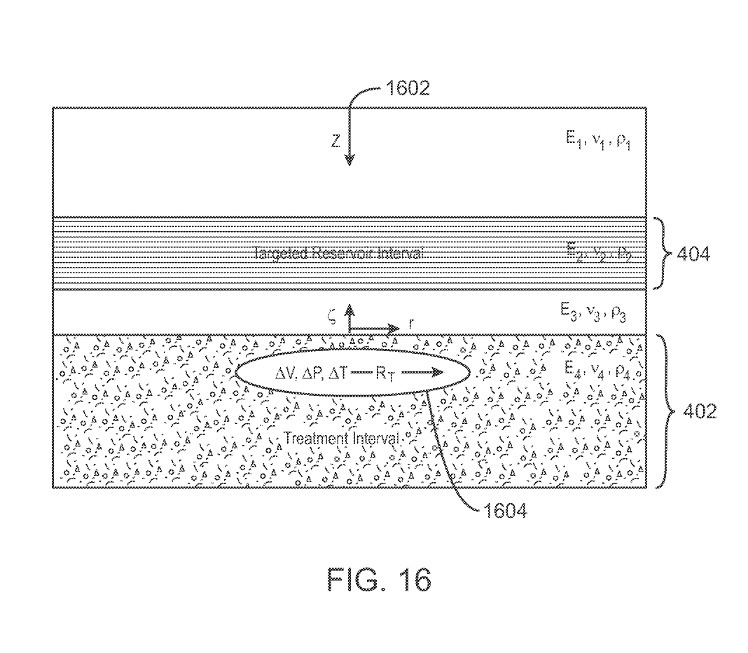

The methods described in FIGS. 13-15 can be used in several ways to determine treatment techniques to be used for the generation of D-Fracs. In one embodiment, a standard numerical approach, such as finite element or finite difference, or an analytical method is use to model the treatment process, associated volume changes, stresses, and displacements as discussed with respect to FIG. 16. The shape of displacements to be created by each candidate treatment type is determined. The stress change within the target (production) interval for each potential treatment method is determined For each treatment type, a rapid non-dimensional analysis-based approach is used to determine the treatment depth and location that result in the largest delamination extent and meet the minimum (or maximum) slip threshold.

In another embodiment, a standard numerical approach or an analytical method is used to build a representative model of the treatment and reservoir zones including potential delamination planes. The delamination extent and slip along each bedding plane is evaluated. For each treatment type, a determination is made of the treatment depth and location that results in the largest delamination extent and meets the minimum (or maximum) slip threshold. The analysis is repeated for every combination of depth/size for each potential treatment technique

FIG. 16 is a drawing of a conceptual model 1600 of a reservoir interval, e.g., a hydrocarbon bearing subterranean formation 404, and a treatment interval, e.g., zone 402. A central axis 1602 represents the location that a well would pass through the formations of the conceptual model 1600. In the conceptual model 1600, numerical modeling, i.e., finite element or finite difference method, or analytical methods may be used to determine stresses and displacements for an arbitrary number of material layers (four shown here) during an applied treatments, for example, in the zone 402 below the hydrocarbon bearing subterranean formation 404. The information determined may include a volume change, ΔV, pressure change, ΔP, and/or temperature change ΔT for each layered material with Young's modulus Eᵢ, Poisson ratio vᵢ, and density ρᵢ and be based on inelastic as well as elastic deformation. It can be understood that the conceptual model 1600 may be divided into blocks or cells for the finite element analysis and each cell will have associated values determined from the calculations. Delamination along arbitrary number of weak bedding planes can be determined. The treatment can include a combination of volume, pressure, and temperature changes in a region 1604 in the zone 402 below the reservoir.

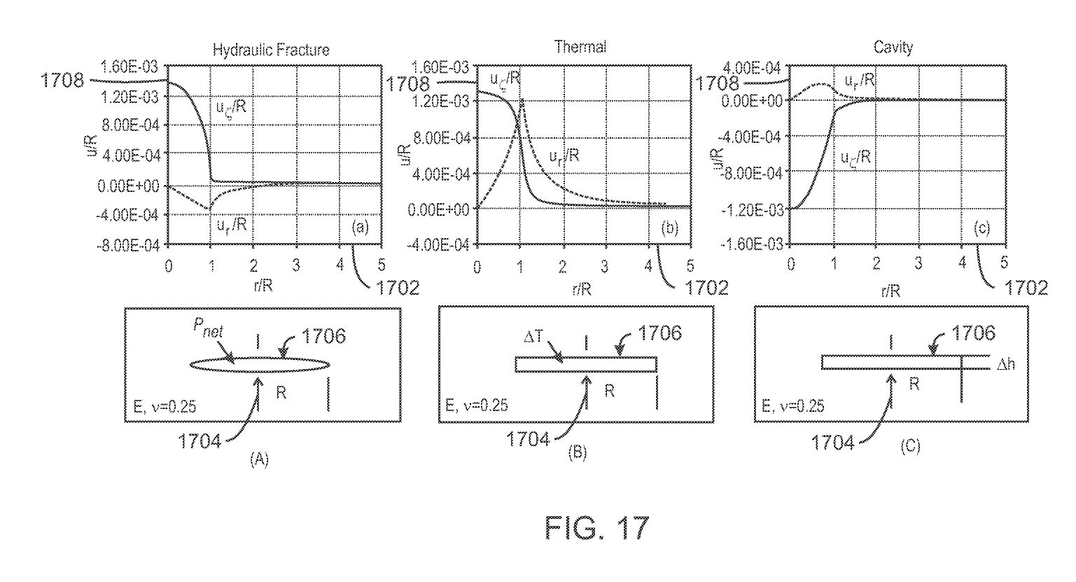

FIG. 17 shows three normalized plots illustrating calculated displacements associated with a treatment. In each plot, the x-axis 1702 represents a normalized distance, r/R, from the center 1704 of a treatment zone 1706, while the y-axis 1708 represents a normalized vertical displacement. In each plot, the curve labeled uᵣ/R represents the normalized radial displacement and the curve labeled u /R represents the normalized vertical displacement. In FIG. 17, plot (A) shows changes due to a hydraulic fracturing of the zone, plot (B) shows changes due to a thermal expansion of the zone, and plot (C) shows changes due to the formation of a cavity within the zone. The solution is non-dimensionalized (normalized) for cases in which the free surface is located far enough away from the reservoir that the change in stress will be approximately independent of depth, i.e., for any reservoir with reservoir depth, Z_{R}>>R_{T}.

The D-Frac modeling is used to calculate volume changes and resulting displacements from various potential treatments, including hydraulic fracture, thermal and poro-elastic methods. The resulting radial, uᵣ, and vertical, u, displacements for various treatment types, as shown in FIGS. 17(A), 17(B), and 17(C), can be determined at the top of the treatment interval. The solution to the elastic stress changes at any radial distance, r, and distance from treatment zone, _{S}can be determined due to an applied displacement at the top of the treatment interval, with maximum uₘₐₓ, over a zone with radius R_{T}. When the reservoir is far from the free surface, the stress changes can be expressed as shown in Eqn. 1.

$$\frac{Δ {σ}_{ij}}{E} = \frac{{u}_{ma x}}{{R}_{T}} {η}_{ij} ( \frac{r}{{R}_{T}} , \frac{ζ}{{R}_{T}} ) \qquad Eqn . 1$$

Since the solutions are normalized, they may not have to be recalculated for every potential treatment, but may be calculated once using the properties of the rock formation in the treatment zone, and then scaled to different treatments.

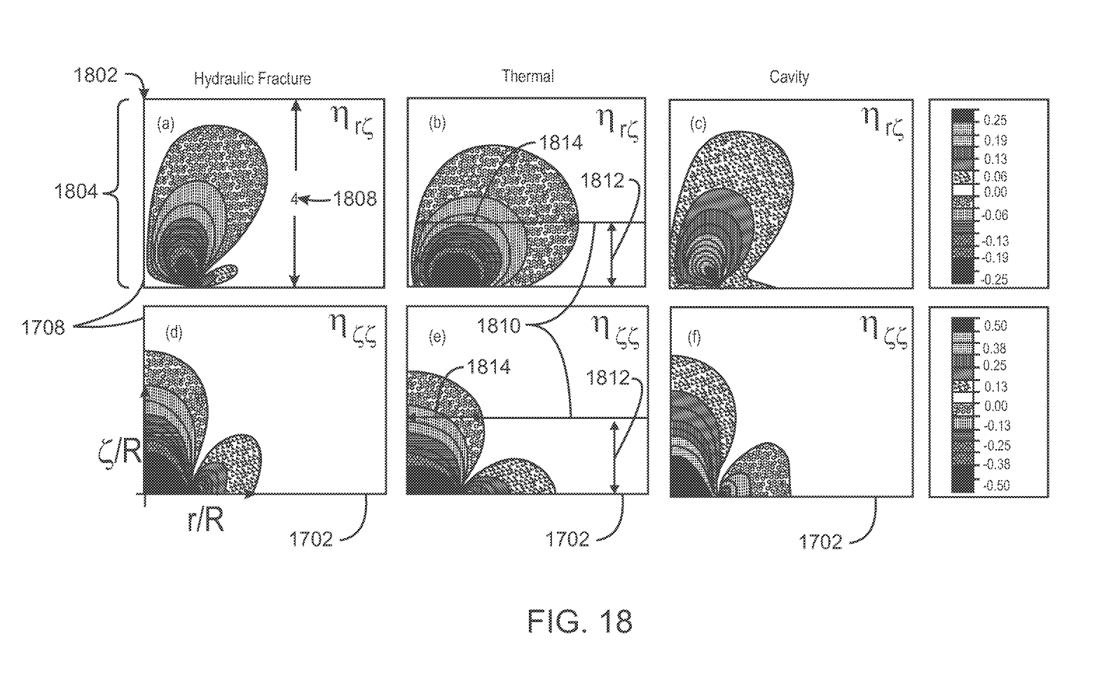

FIG. 18 shows six normalized plots illustrating stress change shape functions caused by displacements in a treatment interval. In each plot, the x-axis 1702 represents a normalized distance, r/R, from well 1802, while the y-axis 1708 represents the normalized displacements. The upper row of plots 1804 show shear stresses, while the lower set of plots 1806 show vertical stress. The height 1808 of each plot corresponds to four times the treatment radius. The stress changes resulting from potential treatments can be used to provide a rapid estimate of potential delamination extent and bulk permeability change within the reservoir. For example, a line 1810 drawn through the plot can indicate the stress changes that would result from the treatment radius 1812 at that line. The resulting stress field 1814 can be compared to the measured strength for the target interval. If the stress exceeds the strength, the formation will delaminate over the stress field 1814. This may be used to maximize the area of delamination.

The stress changes shape functions, ᵢⱼ(r/R_{T}, /R_{T}) displayed in FIG. 18 depend only on location and treatment shape and are independent of the size of the applied treatment and the treatment type. Further, the areas can be scaled, since they are in normalized dimensions. Larger areas may result in higher stress, and more breakage, but may exceed the potential volume of the treatment interval. The horizontal and vertical shape functions can also be used to evaluate permeability enhancement due to reduction of compressive stresses, for example, due to a volumetric decrease in a treatment interval resulting in a volumetric increase within the reservoir by using a relationship between stress and joint aperture.

The total stresses in the reservoir due to an applied displacement as shown in FIG. 18 can be determined analytically by adding the stress changes of Eqn. (1) to the initial stress field. This can be determined by building on the solution for a force at a point of an indefinitely extended solid or through numerical solution, e.g., finite element, finite difference, etc., to the initial stress field determined from field data, ᵢⱼ⁰(x,y,z). A lower bound on the delamination extent can be rapidly determined for any treatment method by searching along every depth for zones where the total shear stress exceeds a shear failure criterion, such as but not limited to the Mohr-Coulomb frictional strength criterion, which may depend on bedding plane material properties (friction, cohesion), the components of stress, and pore pressure.

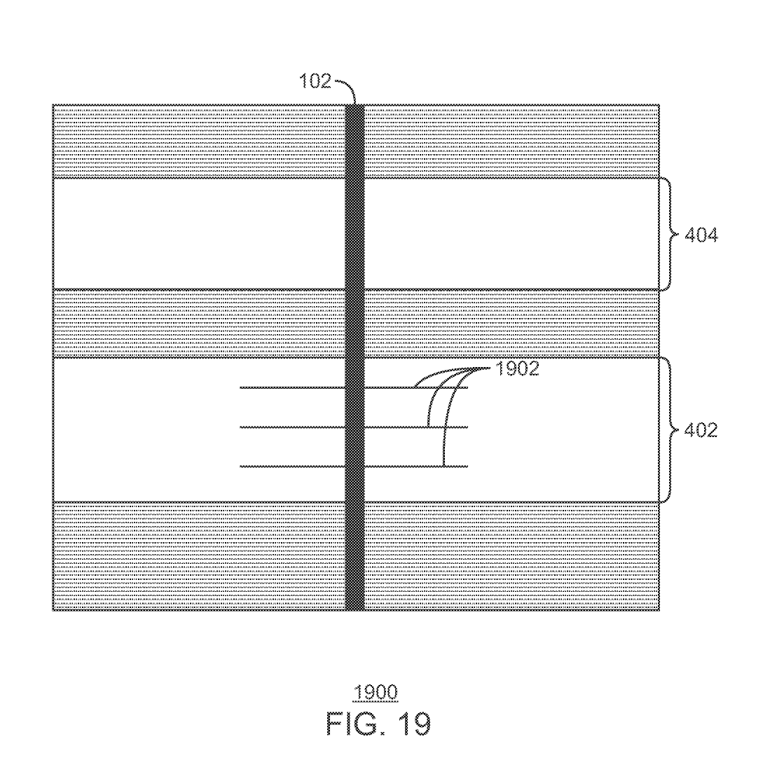

FIG. 19 is a drawing 1900 of a technique that may be useful for increasing the effects of the treatment of a zone 402 on the hydrocarbon bearing subterranean formation 404. Like numbered items are as described with respect to FIG. 4. In the technique, multiple treatment points 1902 are created in the zone 402. As the injection technique described may take a significant amount of time to effect a change in the zone 402, the use of multiple treatment points 1902 may amplify the effects, shortening the treatment time. The treatment points 1902 may be fractures, injection locations for poroelastic expansion of the zone 402, locations of heat sources for thermal expansion of the zone 402, and the like. Each of the treatment points 1902 may be successively or concurrently inflated by the pumping of high pressure fluid into the treatment points 1902. The expansion at multiple treatment points 1902 may increase the stress applied to the hydrocarbon bearing subterranean formation 404, increasing the number or extent of the fractures in a fracture field. This technique may be added to the potential treatments to decrease the time or extent of the treatments and shortening the treatment time.

### Monitoring the Treatment

Monitoring and controlling the treatments described herein may be performed by a number of techniques. Stimulation treatments often show their signatures through earth deformation on the surface or within a subterranean formation, which may be captured by appropriate surveillance or monitoring methods. By the measured deformation pattern and magnitude, it is possible to determine whether a desired treatment has been effected. For example, if an axisymmetric deformation pattern is detected on the surface, one can conclude that treatment is being performed through a horizontal treatment fracture. However, if surface deformation shows two peaks separated by a trough, then treatment is being performed through a vertical fracture. Modeling efforts may be used to establish a direct correlation between surface or subsurface deformation magnitudes and delamination extent in the reservoir for any given geology. The correlation, when implemented in a computer-based system and combined with real-time monitoring technology, may be used to provide on-the-job treatment feedback and results prediction. Potential surveillance options include, among others, tiltmeter arrays installed on the surface or downhole inside dedicated wells, microseismic monitoring, GPS units installed at selected locations on the surface, and InSAR (Interferometric Synthetic Aperture Radar) images of the surface before and after the treatment.

Tiltmeters are useful devices for monitoring the treatment as they can precisely measure the earth deformation induced by the treatment. In addition, they may easily communicate with a computer system so that real-time treatment feedback and optimization may be implemented.

Microseismic technology may be used to obtain the locations of the shearing events accompanying the treatment, from which approximate shape of the treatment may be obtained. Microseismic technology can also be used for real-time monitoring of the treatment, but it cannot accurately provide the size and shape of the treatment.

Both GPS units and InSAR images may be used to measure the surface deformation caused by subterranean treatment. Due to the generally low resolution (>1 mm) of these techniques, they are applicable only if the treatment volume is extremely large. In addition, real-time monitoring may be difficult to implement as both GPS and InSAR rely on communication with satellites.

### Computing Configurations

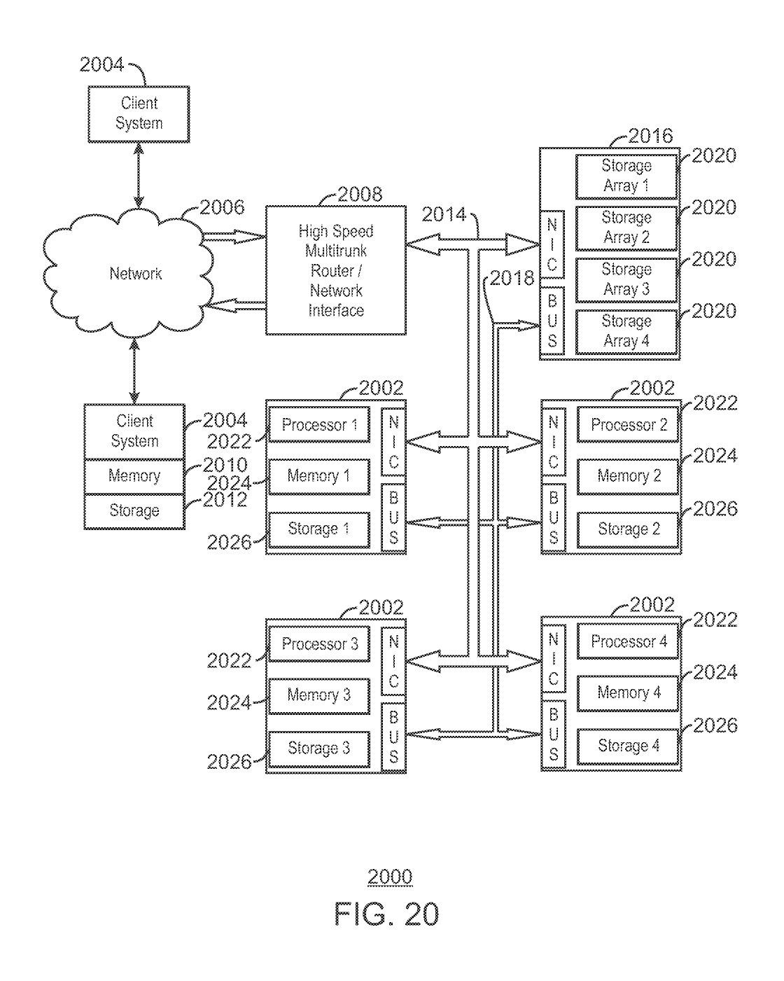

FIG. 20 is a block diagram of exemplary cluster computing system 2000 that may be used to implement the present techniques, in accordance with exemplary embodiments of the present techniques. The cluster computing system 2000 illustrated has four computing units 2002, each of which may perform calculations for a part of the finite element analysis calculations. However, one of ordinary skill in the art will recognize that the present techniques are not limited to this configuration, as any number of computing configurations may be selected. For example, a smaller analysis may be run on a single computing unit 2002, such as a workstation, while a large finite element analysis calculation may be run on a cluster computing system 2000 having 10, 100, 1000, or even more computing units 2002.

The cluster computing system 2000 may be accessed from one or more client systems 2004 over a network 2006, for example, through a high speed network interface 2008. The computing units 2002 may also function as client systems, providing both local computing support, as well as access to the wider cluster computing system 2000.

The network 2006 may include a local area network (LAN), a wide area network (WAN), the Internet, or any combinations thereof. Each of the client systems 2004 may have non-transitory, computer readable memory 2010 for the storage of operating code and programs, including random access memory (RAM) and read only memory (ROM). The operating code and programs may include the code used to implement all or any portions of the methods discussed herein, for example, as discussed with respect to FIG. 5. Further, the non-transitory computer readable media may hold geologic models, rock physics models, and treatment models as discussed above. The client systems 2004 can also have other non-transitory, computer readable media, such as storage systems 2012. The storage systems 2012 may include one or more hard drives, one or more optical drives, one or more flash drives, any combinations of these units, or any other suitable storage device. The storage systems 2012 may be used for the storage of the models, code, data, and other information used for implementing the methods described herein.

The high speed network interface 2008 may be coupled to one or more busses in the cluster computing system 2000, such as a communications bus 2014. The communication bus 2014 may be used to communicate instructions and data from the high speed network interface 2008 to a cluster storage system 2016 and to each of the computing units 2002 in the cluster computing system 2000. The communications bus 2014 may also be used for communications among computing units 2002 and the storage array 2016. In addition to the communications bus 2014 a high speed bus 2018 can be present to increase the communications rate between the computing units 2002 and/or the cluster storage system 2016.

The cluster storage system 2016 can have one or more non-transitory, computer readable media devices, such as storage arrays 2020 for the storage of models, data, visual representations, results, code, or other information, for example, concerning the implementation of and results from the methods of FIGS. 13-15, such as, for example, the finite element analysis results. The storage arrays 2020 may include any combinations of hard drives, optical drives, flash drives, holographic storage arrays, or any other suitable devices.

Each of the computing units 2002 can have a processor 2022 and associated local tangible, computer readable media, such as memory 2024 and storage 2026. Each of the processors 2022 may be a multiple core unit, such as a multiple core CPU or a GPU. The memory 2024 may include ROM and/or RAM used to store code, for example, used to direct the processor 2022 to implement the methods discussed with respect to FIGS. 13-15. The storage 2026 may include one or more hard drives, one or more optical drives, one or more flash drives, or any combinations thereof. The storage 2026 may be used to provide storage for models, intermediate results, data, images, or code associated with operations, including code used to implement the methods of FIGS. 13-15.

The present techniques are not limited to the architecture or unit configuration illustrated in FIG. 20. For example, any suitable processor-based device may be utilized for implementing all or a portion of embodiments of the present techniques, including without limitation personal computers, networks personal computers, laptop computers, computer workstations, GPUs, mobile devices, and multi-processor servers or workstations with (or without) shared memory. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

The techniques described herein use stimulation by fracture “delamination” which minimizes direct fluid contact on rock fracture face, thereby reducing the potential for formation damage and need for flowback clean-up. The fracture “conductivity” is created in-situ over the full fracture dimensions, thereby enhancing productivity and reducing the need for proppant. The modeling calculations utilize a linearity principal to allow rapid calculation of total stresses associated with the proposed treatment, making the selection of treatments more efficient. Core-calibrated techniques are used to determine bedding plane strength and permeability enhancement, which can be combined with the modeling techniques to identify specific treatments for fields. Log data is combined with the total stresses associated with treatment to screen treatment type and to select optimum treatment depth and size. The methods allow a comparison of multiple treatment methods by size or energy required for each to reach desired delamination extent, slip, and permeability enhancement.

Embodiments of the claimed subject matter may include the methods and systems disclosed in the following lettered paragraphs:

A. A method for fracturing a formation, including:
generating a subsurface model including the production formation and a zone proximate to the production formation;
simulating a plurality of scenarios in which a volumetric change is created in the zone proximate to the production formation;
selecting a scenario from the plurality of scenarios to stimulate the production formation; and
performing the scenario to create a fracture field in the production formation.

B. The method of paragraph A, including modeling a mechanical stress in the production formation resulting from the volumetric change in the zone proximate to the production formation.

C. The method of paragraph B, wherein the mechanical stress is applied to only a portion of the zone so as to create a bending motion in the production formation and cause the fracture field to form through delamination.

D. The method of paragraph B, wherein the mechanical stress is applied to only a portion of the zone so as to create a shear stress in the production formation.

E. The method of paragraph B, wherein the mechanical stress is applied to only a portion of the zone so as to achieve a reduction in mean normal stress in the production formation.

F. The method of paragraph A, further including simulating cycles of volumetric change to determine an effect on rubblization along a delaminated joint.

G. The method of paragraph A, including:
simulating a volume change in the zone; and
scaling the volume change in at least a portion of the plurality of scenarios.

H. The method of paragraph A, including determining a size for the fracture field in the production interval based, at least in part, on a distance between the zone and the production interval.

I. The method of paragraph A, wherein the scenario includes creating a volumetric change by contracting the zone through chemical treatments, mechanical erosion, or both.

J. The method of paragraph A, including producing a hydrocarbon from the production formation.

K. The method of paragraph A, including creating a horizontal fracture from a production well to the fracture field.

L. A hydrocarbon production system, including:
a hydrocarbon reservoir;
a zone proximate to the hydrocarbon reservoir;
a stimulation well drilled to the zone; and
a stimulation system configured to create a volumetric change in the zone based, at least in part, on a scenario identified by a simulation of the hydrocarbon reservoir and the zone.

M. The hydrocarbon production system of paragraph L, wherein the zone includes a rock layer in an underburden.

N. The hydrocarbon production system of paragraph L, including a production well drilled into the hydrocarbon reservoir.

O. The hydrocarbon production system of paragraph L, including a production well drilled into the hydrocarbon reservoir from the stimulation well.

Still other embodiments of the claimed subject matter may include the methods and systems disclosed in the following numbered paragraphs:

1. A method for fracturing a formation, including:
generating a subsurface model including the production formation and a zone proximate to the production formation;
simulating a plurality of scenarios in which a volumetric change is created in the zone proximate to the production formation;
selecting a scenario from the plurality of scenarios to stimulate the production formation; and
performing the scenario to create a fracture field in the production formation.

2. The method of paragraph 1, including modeling a mechanical stress in the production formation resulting from the volumetric change in the zone proximate to the production formation.

3. The method of paragraph 2, wherein the mechanical stress is applied to only a portion of the zone so as to create a bending motion in the production formation and cause the fracture field to form through delamination.

4. The method of paragraph 2, wherein the mechanical stress is applied to only a portion of the zone so as to create a shear stress in the production formation.

5. The method of paragraph 2, wherein the mechanical stress is applied to only a portion of the zone so as to achieve a reduction in mean normal stress in the production formation.

6. The method of paragraph 1, further including simulating cycles of volumetric change to determine an effect on rubblization along a delaminated joint.

7. The method of paragraph 1, including measuring the delamination stress of a rock sample from the production formation.

8. The method of paragraph 1, including mapping in-situ stresses across the production formation.

9. The method of paragraph 1, wherein the zone includes a rock layer in an underburden.

10. The method of paragraph 1, including:
simulating a volume change in the zone; and
scaling the volume change in at least a portion of the plurality of scenarios.

11. The method of paragraph 1, including simulating a stress placed on the production formation by a volumetric increase in the zone.

12. The method of paragraph 1, including determining a size for the fracture field in the production interval based, at least in part, on the volumetric change.

13. The method of paragraph 1, including determining a size for the fracture field in the production interval based, at least in part, on a bedding plane strength.

14. The method of paragraph 1, including determining a size for the fracture field in the production interval based, at least in part, on a distance between the zone and the production interval.

15. The method of paragraph 1, wherein the scenario includes creating a volumetric change by thermally expanding the zone.

16. The method of paragraph 1, wherein the scenario includes creating a volumetric change by expanding the zone by a pressurized fluid.

17. The method of paragraph 1, wherein the scenario includes creating a volumetric change by expanding the zone with explosives.

18. The method of paragraph 1, wherein the scenario includes creating a volumetric change by contracting the zone through chemical treatments, mechanical erosion, or both.

19. The method of paragraph 1, including producing a hydrocarbon from the production formation.

20. The method of paragraph 1, including creating a horizontal fracture from a production well to the fracture field.

21. A method for production of a hydrocarbon from a reservoir, including:
simulating a plurality of scenarios in which a volumetric change is created in a zone proximate to a production formation;
selecting one of the plurality of scenarios to stimulate the production formation;
implementing the scenario to mechanically stress the production formation and create a fracture field;
fluidically coupling the fracture field to a production well; and
producing hydrocarbons from the production well.

22. The method of paragraph 21, wherein the hydrocarbon reservoir includes a tight gas reservoir.

23. The method of paragraph 21, wherein the hydrocarbon reservoir includes a tight oil reservoir.

24. The method of paragraph 21, wherein the hydrocarbon reservoir includes a shale gas reservoir.

25. The method of paragraph 21, wherein the hydrocarbon reservoir includes a coal bed methane reservoir.

26. The method of paragraph 21, wherein a scenario includes causing a volumetric increase in the zone.

27. The method of paragraph 21, wherein a scenario includes cycling a volumetric decrease in the zone.

28. The method of paragraph 21, further including cycling the volumetric change in the zone to rubblize a layer of material along a delamination fracture within the hydrocarbon reservoir.

29. The method of paragraph 21, further including:
fracturing the zones; and
injecting waste product tailings into the zone to prop open the fractures.

30. A hydrocarbon production system, including:
a hydrocarbon reservoir;
a zone proximate to the hydrocarbon reservoir;
a stimulation well drilled to the zone; and
a stimulation system configured to create a volumetric change in the zone based, at least in part, on a scenario identified by a simulation of the hydrocarbon reservoir and the zone.

31. The hydrocarbon production system of paragraph 30, wherein the hydrocarbon reservoir includes a tight gas layer.

32. The hydrocarbon production system of paragraph 30, wherein the zone includes a rock layer in an underburden.

33. The hydrocarbon production system of paragraph 30, including a production well drilled into the hydrocarbon reservoir.

34. The hydrocarbon production system of paragraph 30, including a production well drilled into the hydrocarbon reservoir from the stimulation well.

While the present techniques may be susceptible to various modifications and alternative forms, the exemplary embodiments discussed above have been shown only by way of example. However, it should again be understood that the present techniques are not intended to be limited to the particular embodiments disclosed herein. Indeed, the present techniques include all alternatives, modifications, and equivalents falling within the true spirit and scope of the appended claims.

What is claimed is:

1. A method for fracturing a formation, comprising:
generating a subsurface model comprising the production formation and a zone proximate to the production formation;
simulating a plurality of scenarios in which a volumetric change is created in the zone proximate to the production formation;
selecting a scenario from the plurality of scenarios to stimulate the production formation; and
performing the scenario to create a fracture field in the production formation.

2. The method of claim 1, comprising modeling a mechanical stress in the production formation resulting from the volumetric change in the zone proximate to the production formation.

3. The method of claim 2, wherein the mechanical stress is applied to only a portion of the zone so as to create a bending motion in the production formation and cause the fracture field to form through delamination.

4. The method of claim 2, wherein the mechanical stress is applied to only a portion of the zone so as to create a shear stress in the production formation.

5. The method of claim 2, wherein the mechanical stress is applied to only a portion of the zone so as to achieve a reduction in mean normal stress in the production formation.

6. The method of claim 1, further comprising simulating cycles of volumetric change to determine an effect on rubblization along a delaminated joint.

7. The method of claim 1, comprising measuring the delamination stress of a rock sample from the production formation.

8. The method of claim 1, comprising mapping in-situ stresses across the production formation.

9. The method of claim 1, wherein the zone comprises a rock layer in an underburden.

10. The method of claim 1, comprising:
simulating a volume change in the zone; and
scaling the volume change in at least a portion of the plurality of scenarios.

11. The method of claim 1, comprising simulating a stress placed on the production formation by a volumetric increase in the zone.

12. The method of claim 1, comprising determining a size for the fracture field in the production interval based, at least in part, on the volumetric change.

13. The method of claim 1, comprising determining a size for the fracture field in the production interval based, at least in part, on a bedding plane strength.

14. The method of claim 1, comprising determining a size for the fracture field in the production interval based, at least in part, on a distance between the zone and the production interval.

15. The method of claim 1, wherein the scenario comprises creating a volumetric change by thermally expanding the zone.

16. The method of claim 1, wherein the scenario comprises creating a volumetric change by expanding the zone by a pressurized fluid.

17. The method of claim 1, wherein the scenario comprises creating a volumetric change by expanding the zone with explosives.

18. The method of claim 1, wherein the scenario comprises creating a volumetric change by contracting the zone through chemical treatments, mechanical erosion, or both.

19. The method of claim 1, comprising producing a hydrocarbon from the production formation.

20. The method of claim 1, comprising creating a horizontal fracture from a production well to the fracture field.

21. A method for production of a hydrocarbon from a reservoir, comprising:
simulating a plurality of scenarios in which a volumetric change is created in a zone proximate to a production formation;
selecting one of the plurality of scenarios to stimulate the production formation;
implementing the scenario to mechanically stress the production formation and create a fracture field;
fluidically coupling the fracture field to a production well; and
producing hydrocarbons from the production well.

22. The method of claim 21, wherein the hydrocarbon reservoir comprises a tight gas reservoir.

23. The method of claim 21, wherein the hydrocarbon reservoir comprises a tight oil reservoir.

24. The method of claim 21, wherein the hydrocarbon reservoir comprises a shale gas reservoir.

25. The method of claim 21, wherein the hydrocarbon reservoir comprises a coal bed methane reservoir.

26. The method of claim 21, wherein a scenario comprises causing a volumetric increase in the zone.

27. The method of claim 21, wherein a scenario comprises cycling a volumetric decrease in the zone.

28. The method of claim 21, further comprising cycling the volumetric change in the zone to rubblize a layer of material along a delamination fracture within the hydrocarbon reservoir.

29. The method of claim 21, further comprising:
fracturing the zones; and
injecting waste product tailings into the zone to prop open the fractures.

30. A hydrocarbon production system, comprising:
a hydrocarbon reservoir;
a zone proximate to the hydrocarbon reservoir;
a stimulation well drilled to the zone; and
a stimulation system configured to create a volumetric change in the zone based, at least in part, on a scenario identified by a simulation of the hydrocarbon reservoir and the zone.

31. The hydrocarbon production system of claim 30, wherein the hydrocarbon reservoir comprises a tight gas layer.

32. The hydrocarbon production system of claim 30, wherein the zone comprises a rock layer in an underburden.

33. The hydrocarbon production system of claim 30, comprising a production well drilled into the hydrocarbon reservoir.

34. The hydrocarbon production system of claim 30, comprising a production well drilled into the hydrocarbon reservoir from the stimulation well.
